(19) United States
(12) Patent Application Publication
(10) Pub. No.: US 2018/0247266 A1
(43) Pub. Date: Aug. 30, 2018

(54) ROUTE SCHEDULING OF MULTI-CLASS TRANSPORT VEHICLES

(71) Applicant: Amazon Technologies, Inc., Seattle, WA (US)

(72) Inventors: Brian Allen Knapp, Bellevue, WA (US); David Henry Clark, Bellevue, WA (US); Ricky Neal Batye, North Bend, WA (US)

(21) Appl. No.: 15/967,217

(22) Filed: Apr. 30, 2018

Related U.S. Application Data
(63) Continuation of application No. 14/222,266, filed on Mar. 21, 2014.

(51) Int. Cl. G06Q 10/08

(52) U.S. Cl. CPC G06Q 10/08355

(57) ABSTRACT

Techniques for managing different types of transport vehicles are provided. In some embodiments, a transient warehouse can be established that allows a wide variety of transport vehicles to access items from a more convenient location than a brick-and-mortar location. The transient warehouse can be established in a parking lot or on the side of the road, so that other transport vehicles can access the transient warehouse quickly and deliver items to item requesters more efficiently from a centralized location. The transport vehicles can also pick up items from item providers to replenish items for the transient warehouse, the transient warehouse can access items from a brick-and-mortar location, and/or the transport vehicles can travel to multiple item requesters through optimized transport routes. The meeting location of the transient warehouse may also be optimized based on various constraints (e.g., time of day, seasonality concerns, etc.).

### CROSS-REFERENCE TO RELATED APPLICATIONS

This application is a continuation of U.S. patent application Ser. No. 14/222,266, filed Mar. 21, 2014, the entire contents of which are incorporated by reference for all purposes.

### BACKGROUND

People request items from many different places. For example, some item requesters request items from their homes in lofts or condos in the heart of large cities, while other item requesters are located in small suburbs off of dirt roads. In order to access as many people as possible, item providers employ large networks of transport vehicles to deliver items from the item provider to the item requesters. However, some transport vehicles cannot access every location, there are restrictions on drivers' hours of operation, and delays in shipping often cause the item requesters hassle in getting their items quickly.

### BRIEF DESCRIPTION OF THE DRAWINGS

Various embodiments in accordance with the present disclosure will be described with reference to the drawings, in which:

FIG. 1 illustrates an illustrative transportation management process described herein, according to at least one example;

FIG. 2 illustrates an example architecture for transportation management described herein that includes a transportation management computer and/or a user device connected via one or more networks, according to at least one example;

FIG. 3 illustrates an illustrative flow for route scheduling of multi-type transport vehicles described herein, according to at least one example;

FIG. 4 illustrates an illustrative flow of different types of transport vehicles interacting and exchange an item described herein, according to at least one example;

FIG. 5 illustrates an interaction of different types of transport vehicles described herein, according to at least one example;

FIG. 6 illustrates an example flow diagram for route scheduling of multi-type transport vehicles described herein, according to at least one example;

FIG. 7 illustrates an example flow diagram for route scheduling of multi-type transport vehicles described herein, according to at least one example;

FIG. 8 illustrates an example flow diagram for establishing a transient warehouse described herein, according to at least one example;

FIG. 9 illustrates an example flow diagram for establishing a transient warehouse described herein, according to at least one example;

FIG. 10 illustrates an example flow diagram for establishing a transient warehouse described herein, according to at least one example;

FIG. 11 illustrates an example flow diagram for an interaction of different types of transport vehicles described herein, according to at least one example;

FIG. 12 illustrates an example flow diagram for an interaction of different types of transport vehicles described herein, according to at least one example;

FIG. 13 illustrates an example flow diagram for an interaction of different types of transport vehicles described herein, according to at least one example; and

FIG. 14 illustrates an environment in which various embodiments of managing reviewer analytics described herein can be implemented, according to at least one example.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, a system for transporting an item using multi-type transport vehicles from an item exchange location. In some embodiments, a transport route can be determined for one or more types of transport vehicles, where the types of transport vehicles are subject to different transport rules or restricted to different geographic regions. In some embodiments, a transport vehicle can become a type of transient warehouse that can provide one or more items to other transport vehicles at an item exchange location. The transport routes for the transport vehicles can be determined to optimize the location of the item exchange location for one or more of the transport vehicles, including the transient warehouse/item exchange location. The transport routes can be adapted to include the optimized item exchange location. In some embodiments, the transport vehicles can be configured to quickly exchange perishable items or item containers without removing or otherwise unpacking the perishable items from the item containers. The transport vehicles may include one or more physical characteristics (e.g., a refrigerated tote section, a ramp designed to access a lower floor on a different type of transport vehicle, etc.) and the transport routes for the transport vehicles can be identified based in part on the predicted exchange of items from one transport vehicle to another (e.g., whether the first physical characteristic of the first vehicle is compatible with a second physical characteristic of the second vehicle).

In an illustrative example, an optimized transport route can be determined that allows a wide variety of transport vehicles to access items from a more convenient location than a brick-and-mortar location, including another transport vehicle at an item exchange location. The item exchange location can be established nearly anywhere (e.g., in a parking lot or on the side of the road) that is closer to pick-up or drop-off locations, so that other transport vehicles can access the item exchange location quickly and deliver items to item requesters more efficiently. The transport vehicles can also pick up items from item providers to replenish items for the transport vehicles and/or the transport vehicles can access items from a brick-and-mortar location. The meeting location of the transport vehicles may also be optimized based on various constraints (e.g., time of day, seasonality concerns, traffic, etc.). For example, a delivery performance factor associated with the delivery may be measured. The delivery performance factor may indicate a level of optimization of the selection of the item exchange location and/or a level of optimization of the delivery of the item. The item exchange location may be optimized when the delivery performance factor is above a threshold (e.g., the item is delivered in under 2 days, under 24 hours, under 8 hours, etc.).

A “transport vehicle,” “first or second vehicle,” or “type of transport vehicle” (used interchangeably) can be a machine configured for carrying items, including, but not limited to, an automobile, a van, a tractor, a truck, a semi-trailer, a tank car, a rail car, a bicycle, an unmanned vehicle (e.g., an unmanned aerial vehicle (UAV), a land-based unmanned vehicle, etc.), or a remotely-operated machine. For example, an automobile may include a container, trunk, or seat that can be used to carry items. In another example, a semi-trailer can include a tractor portion that hauls an intermodal container to secure storage of the items. Each of the types of machines can be considered a different “type” of transport vehicle (e.g., subject to different transport rules). In some embodiments, the vehicles that deliver the item are selected from a plurality of vehicles of a common vehicle type.

A “transport route” or “delivery route” can include a series of steps that a transport vehicle can take in order to transport or deliver an item between locations. For example, a transport route can begin at a base location (e.g., a storage yard, a fulfillment center parking lot, etc.), can include instructions for the transport vehicle to retrieve one or more items at a pick-up location before travelling to a second location (e.g., an item provider, a consumer, etc.), can include instructions for transferring the items to a second transport vehicle (e.g., from van to bicycle, from rail car to semi-trailer truck, etc.), can include instructions for picking up one or more items at a second pick-up location, can include instructions for dropping off one or more items at a drop-off location (e.g., an item provider, a consumer, etc.), and can include instructions for ending at the base location. The transport route may include one or more roads, highways, streets, pathways, railways, sea routes, air routes, or other ways of accessing one location from another.

A “transport rule” can include one or more restrictions for a particular transport vehicle traveling on a particular transport route or within a particular geographic region. For example, a large transport vehicle (e.g., a transport vehicle with a length longer than 50 feet) may be restricted from traveling on some streets in a large city (e.g., to alleviate traffic concerns, because of traffic rules provided by a city, because it may be easier for a smaller vehicle to access locations than a larger vehicle, or the like). In another example, a transport rule can identify a particular type of transport vehicle needed to access the location (e.g., boats and planes may be able to access an island, while an automobile may not). In yet another example, a transport rule can identify a particular transport vehicle based on the type of item the vehicle transports (e.g., only certain types of transport vehicle can transport hazardous materials).

A “base location” can include a location that stores transport vehicles when the vehicles are not in use, including but not limited to a storage yard, a fulfillment center or item repository parking lot, a garage, or the like. The base location may be identified at the start of a transport route and can factor into a calculation of an optimal item exchange location. For example, one transport vehicle can have a base location in Los Angeles and another transport vehicle can have a base location in San Diego. The determined transport route can include an item exchange location between Los Angeles and San Diego, including Orange County. In another example, the base location may change during a time duration. For example, a transport vehicle may have a base location in Seattle on January 1^{st}, but change the base location to San Francisco on January 10^{th}. In some examples, the base location may change (or stay the same) for the determined transport routes (e.g., one base location on the first day, a different base location on the second day, etc.).

A “fulfillment center” or “item repository” (used interchangeably) can be a brick-and-mortar facility used for providing and receiving items from transport vehicles. The fulfillment center can include particular attributes that are found in a standard building, including electricity, lighting, computer systems, networks, etc. For example, a fulfillment center can include a computer system that is used to keep track of items, transport vehicles, and transport routes. In another example, a fulfillment center can provide a parking lot or storage facility used to keep transport vehicles when the vehicles are not in use. A fulfillment center may remain relatively stationary over an extended period of time (e.g., built on a foundation, using building permits, etc.). In some examples, the base location is a fulfillment center or item repository for managing the item.

An “item exchange location” or “physical location” can include a location where one or more transport vehicles meet to exchange an item. The item exchange location can include a parking lot, commercial retail space, a residential location, a side of the road (roadside), under a street light on a sidewalk, and the like. In some examples, the transport vehicle can stop at the item exchange location to avoid stopping at the base location or a brick-and-mortar fulfillment center or repository center. The item exchange location can move, change, or follow a particular transport route (e.g., the item exchange location is located on Main Street in the morning and Alpha Way in the afternoon). The item exchange location can be transiently determined (e.g., the item exchange location is located at Main Street and dynamically changed to Alpha Way based on a transportation factor like a traffic accident). In other examples, the item exchange location can include a fulfillment center or item repository.

The item exchange location is determined and/or updated using various methods. For example, the item exchange location can be determined to optimize the efficiency of the transport route while including a maximum number of pick-up, drop-off, and/or base locations. In another example, the item exchange location is determined by identifying potential item exchange locations (e.g., items that are approved as feasible, not under construction, open to the public, etc.) and choosing the item exchange location with the highest ranked transportation factor. In another example, multiple item exchange locations are available, multiple transport routes are determined (e.g., using an integral route optimization process), and the item exchange location is identified that correlates with the respective rankings of the transport routes. Additional methods of determining the item exchange location are described through embodiments of the present disclosure.

A “pick-up location” or “drop-off location” can include a location where the transport vehicle visits in order to pick-up or drop-off an item. For example, the transport vehicle may visit an item manufacturer's location to retrieve a loaf of bread (the pick-up location) and also visit a consumer's residential location to drop-off the load of bread (the drop-off location). In some examples, the pick-up or drop-off location may be another transport vehicle, so that one transport vehicle can retrieve a loaf of bread from the side of a truck (the pick-up location) and also visit an item provider's retail location to drop-off the loaf of bread (the drop-off location).

A “physical characteristic for a type of vehicle” can include one or more features of the transport vehicle that can be considered when transporting or optimizing the transport and delivery of items, including enabling the transport vehicles to exchange items more efficiently (e.g., the first physical characteristic of the first vehicle is compatible with a second physical characteristic of the second vehicle). The physical characteristic of the type of vehicle may replace a physical characteristic that is missing by not exchanging items at a fulfillment center or item repository (e.g., a physical characteristic can include a computer system to replace the missing computer system that is normally provided the fulfillment center). For example, a physical characteristic can include an opening on the side of the transport vehicle. A particular type of transport vehicle can include a customized opening so that the transport vehicles from different types can be configured to include similar size openings that align when the first transport vehicle and the second transport vehicle are next to each other. In another example, the physical characteristic can include a ramp between the transport vehicles (e.g., a ramp built in to the floor of one type of transport vehicle) to transfer the item between the first transport vehicle and the second transport vehicle. In yet another example, the physical characteristic can include rails that align when the first transport vehicle and the second transport vehicle are next to each other in order to transfer the item between the first transport vehicle and the second transport vehicle. In some embodiments, the rails may be fitted to item containers (e.g., pallets, totes, boxes, refrigerated containers, etc.), so that the item container or storage rack rolls on the rails between the first transport vehicle and the second transport vehicle.

In some examples, the compatibility between the physical characteristics can enable automatic transfer and/or automatic exchange of the item from a first vehicle to a second vehicle. For example, the automatic transfer may be capable without unpacking the item from a tote that contains the item and at least another item (e.g., automatic item transfer from a first vehicle to a second vehicle). In another example, a first vehicle is configured to provide the item to the second vehicle without unpacking the item from a tote based at least in part on a common vehicle type.

It should be appreciated that these and other examples are provided for illustrative purposes and should not be used to restrict embodiments of the present disclosure.

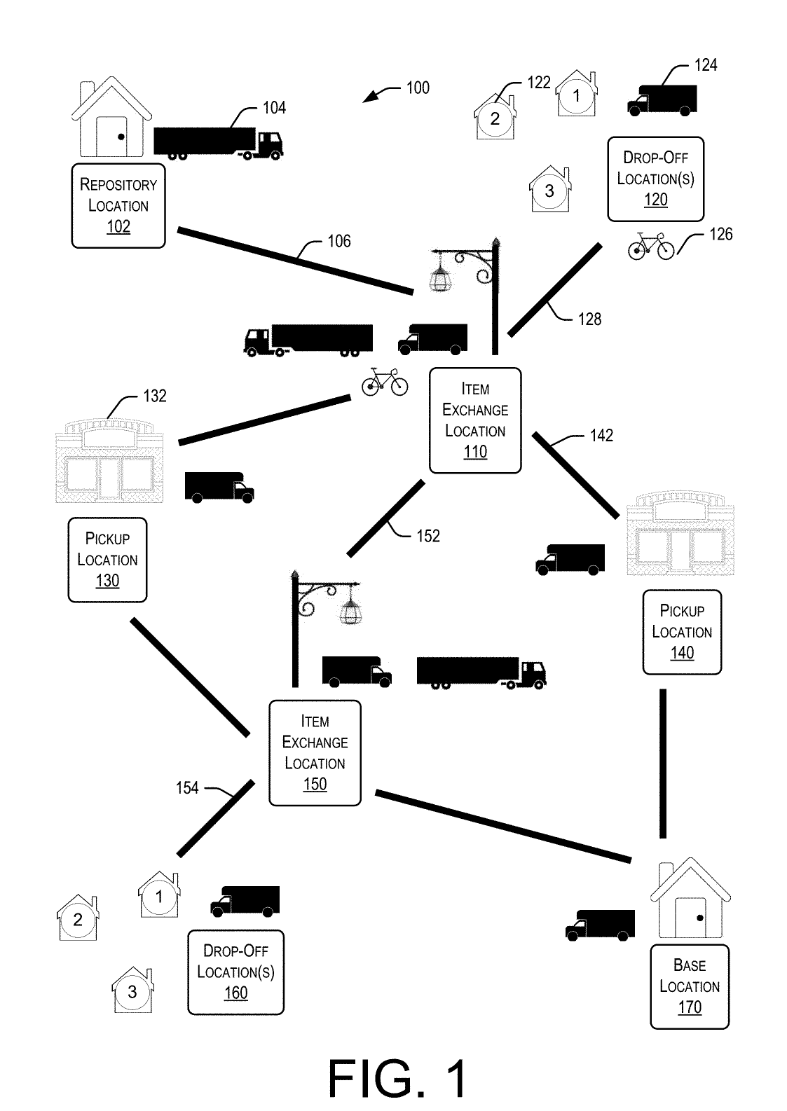

FIG. 1 illustrates an illustrative transportation management process described herein, according to at least one example. In a non-limiting example, the illustration 100 can include one or more repository locations 102, transport vehicles 104, 124, 126, portions of transport routes 106, 128, 142, 152, 154, item exchange locations 110, 150, drop-off locations 120, 160, residential location(s) 122, pickup/pick-up locations 130, 140, item provider's location(s) 132, and base location(s) 170. Transport vehicles 104, 124, and 126 may be different types of transport vehicles, including one or more types of transport vehicles that are governed by one or more sets of transport rules. For example, a first vehicle may be governed by a first set of transport rules and the second vehicle may be governed by a second set of transport rules different from the first set of transport rules. It should be appreciated that the number of transport vehicles and locations (e.g., pick-up locations, drop-off locations, base locations, item provider locations, etc.) are provided for illustrative purposes. More or fewer of each of these transport vehicles, transport routes, or locations may be illustrated in other examples described herein.

In one example, a first transport route can be determined. The transport route can include the first transport vehicle 104 and identify a beginning and/or end of the transport route (e.g., at a base location 170, at a repository location 102). The transport route can include one or more stops or visits along the route and particular portions of the transport route to take during the route. For example, transport route can include a pick-up location 140, traveling on a portion of a transport route 142, and stopping at an item exchange location 110. The transport vehicle may visit the base location, item exchange location, pick-up location, or other locations as part of the transport route.

The transport route can include one or more portions of a transport route 106, 128. For example, a transport vehicle 104 can start at a repository location 102, travel on a portion of a transport route 106 (e.g., a road, highway, etc.) to arrive at an item exchange location 110, travel along a second portion of a transport route 128 to arrive at a drop-off location 120, and end the transport route. In some examples, the transport route may identify a beginning and/or end of the transport route (e.g., at a base location 170) by traveling on one or more portions of transport routes.

The transport route can be determined as part of an integral route optimization process (e.g., when more than one item exchange location is available). For example, the transport route can be determined as part of an integral route optimization process to include the plurality of delivery locations (e.g., pick-up locations, drop-off locations, etc.) and one of the first item exchange location or second item exchange location. The integral route optimization process may identify the minimum number of transport vehicles needed to transport items. The integral route optimization process may also identify the shortest transportation route (e.g., using a shortest path algorithm) to identify a minimum duration of time that the transport vehicle can spend traveling to various locations. The integral route optimization process can identify a maximum duration of time that the transport vehicle can spend delivering the items to the locations (e.g., maximum number of stops with the least amount of driving). The integral route optimization process can consider the roads of the transport route, locations of the item requesters/users, locations of the item providers (e.g., including other transport vehicles), and any suitable transportation factors that may affect the efficiency of a first transport route in comparison with a second transport route. Any suitable route optimization algorithm may be adapted to incorporate transient item exchange locations. Routes may be adapted to incorporate separately selected item exchange locations. Alternatively, or in addition, optimal routes and optimal transient item exchange locations may be determined as part of an integral optimization calculation and/or process.

A transport vehicle may access a particular geographical region. For example, transport vehicle 104 may access the upper portion of illustration 100, including a base location (not shown), a repository location 102, an item exchange location 110, and a drop-off location 120, but may be restricted from traveling on portions of the transportation route to access either pick-up location 130 or 140. The pick-up locations 130, 140 may be inaccessible to the transport vehicle 104 because it is a particular type of transport vehicle (e.g., too heavy to travel on particular roads, not equipped to handle hazardous materials, etc.) or transport rules associated with the transport vehicle itself (e.g., the driver of the transport vehicle can only travel for 8-hours in a day, the driver is not allowed to travel out of a geographical region where the driver is unlicensed, etc.). In some examples, a first vehicle is designated for exclusively delivering items within a first geographical region and the second vehicle is designated for exclusively delivering items within a second geographical region. In some embodiments, the transport vehicle 104 may meet at an item exchange location 110, exchange the item with a different type of transport vehicle (e.g., transport vehicles 124 or 126), and allow the other transport vehicles to transport the item to another location (e.g., a different geographical region) along a different transport route.

The item may be picked up from various locations, including a repository location 102 (e.g., a fulfillment center, a transient warehouse, a brick-and-mortar building), an item exchange location 110, 150, or a pick-up location 130, 140. A transport route can be identified so that a transport vehicle 124 travels on a portion of the transport route 128, picks up the item from a second transport vehicle at an item exchange location 110, travels on other portions of the transport route 152, 154, and provides the item to a drop-off location (e.g., a residential home).

The item exchange location 110, 150 can include a location where one or more transport vehicles meet to exchange an item. The item exchange location can include a parking lot, commercial retail space, a residential location, a side of the road, under a street light on a sidewalk, and the like. In some examples, the transport vehicle can stop at the item exchange location to avoid stopping at the base location or a brick-and-mortar fulfillment center. The item exchange location can move, change, or follow a particular transport route (e.g., the item exchange location is located on Main Street in the morning and Alpha Way in the afternoon). The item exchange location can be transiently determined (e.g., the item exchange location is located at Main Street and dynamically changed to Alpha Way based on a transportation factor like a traffic accident).

Transportation factors can include a variety of information that may affect pick-up or delivery of items, efficiency of transport routes, or other issues. For example, transportation factors can include a schedule of a driver operating the first vehicle, a cost of operating the first vehicle with respect to the route, an identification of a least amount of overtime for a driver operating the first vehicle, an amount of time that the item is to be transported, or a distance between the pick-up location and the drop-off location.

The item exchange location can be optimized (e.g., a delivery optimization factor, optimizing a delivery of an item). For example, after a first item exchange location is identified, a second item exchange location can be identified among a plurality of item exchange locations that optimizes a first transport route and second transport route with respect to a transportation factor. The first transport route and the second transport route can be adapted to include the second item exchange location. In some examples, the first transport route and the second transport route can be optimized to schedule a transfer of at least one item from the first transport vehicle to the second transport vehicle at the second item exchange location. The optimization criteria can include cost, a schedule of a driver operating the first transport vehicle or the second transport vehicle, or an ease of access to the second item exchange location (e.g., by a freeway).

In other examples, the delivery of the item may be optimized (e.g., instead of the item exchange location), based at least in part on the transportation factor. In some examples, the updated item exchange location is determined based at least in part on a transportation factor for optimizing a delivery of the item by a second transport vehicle (e.g., a first vehicle and a second vehicle deliver the item).

The item exchange location 110, 150 can be selected from a plurality of candidate locations. For example, the candidate locations can include all suitable of the parking lots in Seattle. In another example, the candidate locations can include any suitable road with street parking available. In some examples, the item exchange location can be selected from a plurality of item exchange locations after a particular item exchange location is have been approved (e.g., the parking lot is not blocked by construction, the warehouse location is available for rental, the sidewalk is easily accessible by a highway, otherwise vetted for feasibility of delivering the item, etc.). In yet other examples, the plurality of potential item exchange locations that are located in the union of a first geographical region and a second geographical region associated with a first transport vehicle or transport route and a second transport vehicle or transport route, respectively. The plurality of potential item exchange locations can include one or more movable or temporary locations that are identified for a purpose other than item exchanges (e.g., parking a car) and the plurality of potential item exchange locations unsupported by item exchange infrastructure.

The item exchange location may include respective rankings. For example, one item exchange location may help optimize delivery of an item based in part on the respective ranking associated with the potential item exchange location. The item exchange location may be a location with a higher ranked transportation factor than another item exchange location (e.g., easier to access by freeway, cheaper to park for an extended amount of time, etc.). The respective rankings may be identified based on which ranking is higher (e.g., identify, based on a delivery optimization factor, that a first respective ranking of the first item exchange location is higher than a second respective ranking of the second item exchange location).

For example, a plurality of potential item exchange locations can be identified and a first item exchange location can be determined because it includes a higher ranked transportation factor than a second item exchange location. The transportation routes can include the first item exchange location instead of the second item exchange location because of this higher transportation factor. Transportation factors can be associated with scalar quantities. In some examples, the transportation factors can be ranked, computed as a weighted sum of the quantities, and/or a suitable nonlinear combination.

In some examples, a transportation factor can affect an efficiency of delivery of an item. For example, when the item exchange location is easier to access by freeway, cheaper to park for an extended amount of time, and the like, these transportation factors may allow the transport vehicles to access the item exchange location with a higher efficiency of delivery than an item exchange location without the transportation factor (e.g., more difficult access to a freeway, more expensive to park, etc.).

The different transport vehicles 104, 124, 126 may interact with each other at an item exchange location 110, 150 in order to exchange items (e.g., perishable items or item containers). For example, a plurality of perishable items can be stored on an item container for perishable items. A transport route for the first transport vehicle can be identified that includes a pick-up location where the first transport vehicle acquires the perishable items (e.g., the item container for perishable items) and an item exchange location. A second transport route can also be identified for a second transport vehicle that includes the item exchange location as well. The transport vehicles can be instructed to exchange the item container at the item exchange location.

In some examples, the transport vehicles or the item container can include a physical characteristic that allows for more efficient exchange of items. For example, a height, width, depth, size, or shape of the item container can be constructed to transfer the perishable items quickly from the first transport vehicle to the second transport vehicle, without unpacking the perishable items from the item container. The item exchange location can be calculated to maximize a number of delivery or pick-up locations in the first transport route and second transport route based in part on a predicted interaction between the first and second type of vehicles using the first and second physical characteristics. In some examples, the first transport vehicle can be limited by a first transportation factor and equipped with a first physical characteristic for a first type of vehicle, the second transport vehicle limited by a second transportation factor and equipped with a second physical characteristic for a second type of vehicle. The item exchange location can be dynamically updated to the first transport route and the second transport route based in part on the first transportation factor and the second transportation factor. In some examples, at least one transport route may be updated to include the first item exchange location in place of the second item exchange location based at least in part on the first respective ranking being higher than the second respective ranking. An optimal exchange location for the first and second physical characteristics can be determined to facilitate the interaction to exchange the item at the item exchange location.

In some examples, the transport vehicles may be notified of updates or amendments to the transport routes. For example, instructions can be provided for transferring the item between the first vehicle and the second vehicle at the first item exchange location. In another example, the instructions can be provided for the second vehicle to provide the item to a destination. In yet another example, the updated route(s) are provided while at least one of the first or second vehicles are on the first or second routes, respectively.

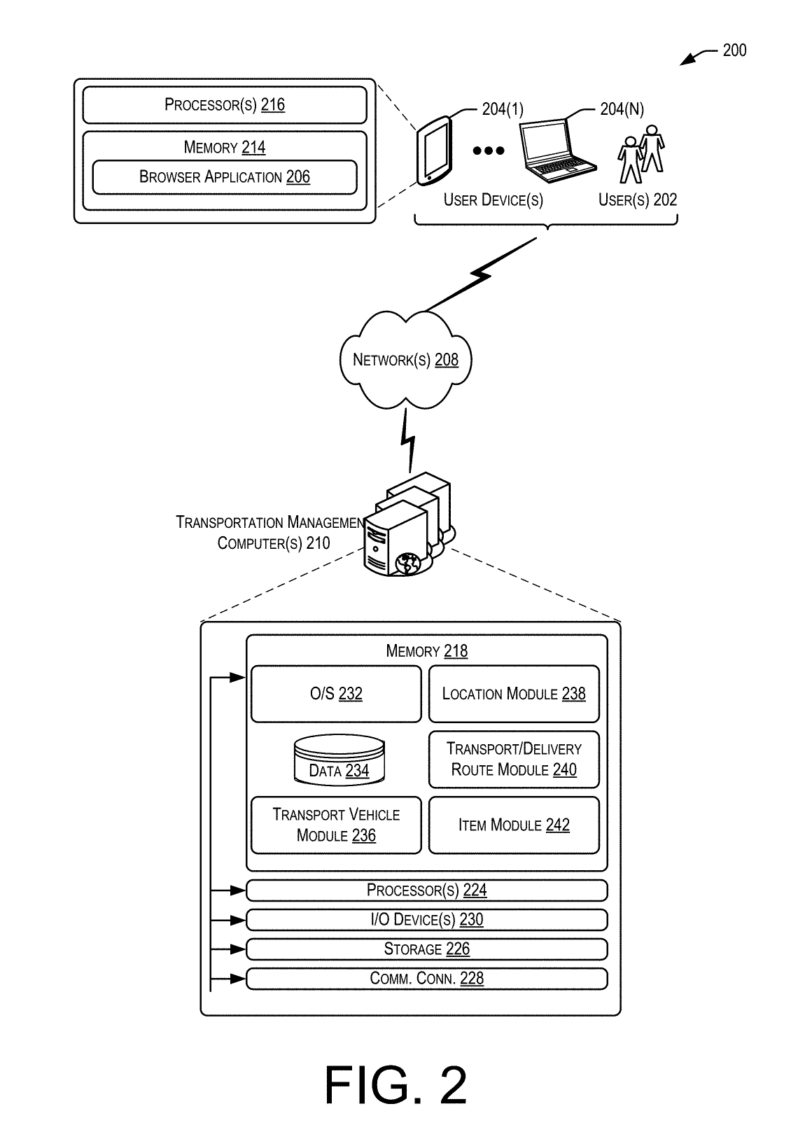

FIG. 2 illustrates an example architecture for transportation management described herein that includes a transportation management computer and/or a user device connected via one or more networks, according to at least one example. In architecture 200, one or more users 202 (i.e., web browser users) may utilize user computing devices 204(1)-(N) (collectively, user devices 204) to access an application 206 (e.g., a web browser), via one or more networks 208. In some aspects, the application 206 may be hosted, managed, and/or provided by a computing resources service or service provider, such as by utilizing one or more service provider computers and/or one or more transportation management computers 210. The one or more transportation management computers 210 may, in some examples, provide computing resources such as, but not limited to, client entities, low latency data storage, durable data storage, data access, management, virtualization, cloud-based software solutions, electronic content performance management, etc. The one or more transportation management computers 210 may also be operable to provide web hosting, computer application development, and/or implementation platforms, combinations of the foregoing, or the like to the one or more users 202. The one or more transportation management computers 210, in some examples, may provide management of transporting one or more items.

In some examples, the networks 208 may include any one or a combination of many different types of networks, such as cable networks, the Internet, wireless networks, cellular networks and other private and/or public networks. While the illustrated example represents the users 202 accessing the application 206 over the networks 208, the described techniques may equally apply in instances where the users 202 interact with the transportation management computers 210 via the one or more user devices 204 over a landline phone, via a kiosk, or in any other manner. It is also noted that the described techniques may apply in other client/server arrangements (e.g., set-top boxes, etc.), as well as in non-client/server arrangements (e.g., locally stored applications, etc.).

As described briefly above, the application 206 may allow the users 202 to interact with a service provider computer, such as to access web content (e.g., web pages, music, video, etc.). The one or more transportation management computers 210, perhaps arranged in a cluster of servers or as a server farm, may host the application 206 and/or cloud-based software services. Other server architectures may also be used to host the application 206. The application 206 may be capable of handling requests from many users 202 and serving, in response, various item web pages. The application 206 can provide any type of website that supports user interaction, including social networking sites, online retailers, informational sites, blog sites, search engine sites, news and entertainment sites, and so forth. As discussed above, the described techniques can similarly be implemented outside of the application 206, such as with other applications running on the user devices 204.

The user devices 204 may be any type of computing device such as, but not limited to, a mobile phone, a smart phone, a personal digital assistant (PDA), a laptop computer, a desktop computer, a thin-client device, a tablet PC, an electronic book (e-book) reader, etc. In some examples, the user devices 204 may be in communication with the transportation management computers 210 via the networks 208, or via other network connections. Additionally, the user devices 204 may be part of the distributed system managed by, controlled by, or otherwise part of the transportation management computers 210 (e.g., a console device integrated with the transportation management computers 210).

In one illustrative configuration, the user devices 204 may include at least one memory 214 and one or more processing units (or processor(s)) 216. The processor(s) 216 may be implemented as appropriate in hardware, computer-executable instructions, firmware, or combinations thereof. Computer-executable instruction or firmware implementations of the processor(s) 216 may include computer-executable or machine-executable instructions written in any suitable programming language to perform the various functions described. The user devices 204 may also include geo-location devices (e.g., a global positioning system (GPS) device or the like) for providing and/or recording geographic location information associated with the user devices 204.

The memory 214 may store program instructions that are loadable and executable on the processor(s) 216, as well as data generated during the execution of these programs. Depending on the configuration and type of user device 204, the memory 214 may be volatile (such as random access memory (RAM)) and/or non-volatile (such as read-only memory (ROM), flash memory, etc.). The user device 204 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 214 may include multiple different types of memory, such as static random access memory (SRAM), dynamic random access memory (DRAM), or ROM.

Turning to the contents of the memory 214 in more detail, the memory 214 may include an operating system and one or more application programs or services for implementing the features disclosed herein, such as via the browser application 206 or dedicated applications (e.g., smart phone applications, tablet applications, etc.). The browser application 206 may be configured to receive, store, and/or display a website or other interface for interacting with the transportation management computers 210. Additionally, the memory 214 may store access credentials and/or other user information such as, but not limited to, user IDs, passwords, and/or other user information. In some examples, the user information may include information for authenticating an account access request such as, but not limited to, a device ID, a cookie, an IP address, a location, or the like. In addition, the user information may include a user 202 provided response to a security question or a geographic location obtained by the user device 204.

In some aspects, the transportation management computers 210 may also be any type of computing devices such as, but not limited to, a mobile phone, a smart phone, a personal digital assistant (PDA), a laptop computer, a desktop computer, a server computer, a thin-client device, a tablet PC, etc. Additionally, it should be noted that in some embodiments, the service provider computers are executed by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment. In some examples, the transportation management computers 210 may be in communication with the user devices 204 and/or other service providers via the networks 208, or via other network connections. The transportation management computers 210 may include one or more servers, perhaps arranged in a cluster, as a server farm, or as individual servers not associated with one another. These servers may be configured to implement the content performance management described herein as part of an integrated, distributed computing environment.

In one illustrative configuration, the transportation management computers 210 may include at least one memory 218 and one or more processing units (or processor(s)) 224. The processor(s) 224 may be implemented as appropriate in hardware, computer-executable instructions, firmware, or combinations thereof. Computer-executable instruction or firmware implementations of the processor(s) 224 may include computer-executable or machine-executable instructions written in any suitable programming language to perform the various functions described.

The memory 218 may store program instructions that are loadable and executable on the processor(s) 224, as well as data generated during the execution of these programs. Depending on the configuration and type of transportation management computers 210, the memory 218 may be volatile (such as RAM) and/or non-volatile (such as ROM, flash memory, etc.). The transportation management computers 210 or servers may also include additional storage 226, which may include removable storage and/or non-removable storage. The additional storage 226 may include, but is not limited to, magnetic storage, optical disks and/or tape storage. The disk drives and their associated computer-readable media may provide non-volatile storage of computer-readable instructions, data structures, program modules and other data for the computing devices. In some implementations, the memory 218 may include multiple different types of memory, such as SRAM, DRAM, or ROM.

The memory 218, the additional storage 226, both removable and non-removable, are all examples of computer-readable storage media. For example, computer-readable storage media may include volatile or non-volatile, removable or non-removable media implemented in any method or technology for storage of information such as computer-readable instructions, data structures, program modules, or other data. The memory 218 and the additional storage 226 are all examples of computer storage media. Additional types of computer storage media that may be present in the transportation management computers 210 may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the transportation management computers 210. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The transportation management computers 210 may also contain communications connection(s) 228 that allow the transportation management computers 210 to communicate with a stored database, another computing device or server, user terminals and/or other devices on the networks 208. The transportation management computers 210 may also include I/O device(s) 230, such as a keyboard, a mouse, a pen, a voice input device, a touch input device, a display, speakers, a printer, etc.

Turning to the contents of the memory 218 in more detail, the memory 218 may include an operating system 232, one or more data stores 234, and/or one or more application programs or services for implementing the features disclosed herein including a transport vehicle module 236, a location module 238, a transport route module 240, and/or an item module 242. In some examples, the transport vehicle module 236 may be configured to identify a type of transport vehicle. For example, a transport vehicle can be a machine that includes means of carrying items, including an automobile, van, tractor, truck, semi-trailer, tank car, rail car, bicycle, unmanned vehicle (e.g., unmanned aerial vehicle (UAV), land-based, etc.), or remotely-operated machine. For example, an automobile may include a container, trunk, or seat that can be used to carry items. In another example, a semi-trailer can include a tractor portion that hauls an intermodal container to secure storage of the items. Each of the types of machines can be considered a different “type” of transport vehicle (e.g., subject to different transport rules).

In some embodiments, the first transport vehicle can be identified to be of a first type of transport vehicle and the second transport vehicle can be identified to be of a second type of transport vehicle. The transport rules can define a geographical region that is accessible to the particular type of transport vehicle. More than one set of transport rules can identify distinct geographical regions associated with each set of transport rules.

The transport vehicle module 236 may also be configured to identify transport rules that govern a type of transport vehicle. The transport rules can include one or more restrictions for a particular transport vehicle traveling on a particular transport route or within a particular geographical region. For example, a large transport vehicle (e.g., a transport vehicle with a length longer than 50 feet) may be restricted from traveling on some streets in a large city (e.g., to alleviate traffic concerns, because of traffic rules provided by a city, because it may be easier for a smaller vehicle to access locations than a larger vehicle). In another example, a transport rule can identify a particular type of transport vehicle needed to access the location (e.g., only boats and planes can access an island). In yet another example, a transport rule can identify a particular transport vehicle based on the type of item the vehicle transports (e.g., only certain types of transport vehicle can transport hazardous materials).

The first type of transport vehicle can be governed by a first set of transport rules that define a first geographical region that is accessible to the first transport vehicle, and the second transport vehicle is a second type of transport vehicle governed by a second set of transport rules that define a second geographical region that is accessible to the second transport vehicle. In some examples, a first vehicle is designated for exclusively delivering first items within a first geographical region and a second vehicle is designated for exclusively delivering second items within a second geographical region. The first geographical region may be different than a second geographical region.

The transport vehicle module 236 may also be configured and/or interact with the transport/delivery route module 240 to provide instructions to a transport vehicle to visit a particular location. For example, a first transport vehicle can be instructed to retrieve an item from a pick-up location before travelling to an item exchange location. In another example, a second transport vehicle can be instructed to deliver the item to a base location and a third transport vehicle can be scheduled to stay in a particular location for a predetermined amount of time. In yet another example, a transport vehicle remains stationary after the transport vehicle arrives at an item exchange location until the transport vehicle departs for a base location. In some examples, the first transport vehicle can visit a plurality of stops outlined by the transport route and/or the second transport vehicle includes no more than one stop outlined by the second transport route.

The transport vehicle module 236 may also be configured to provide and/or update instructions a transport vehicle to pick up or drop off items from locations. For example, the transport vehicle module 236 can provide instructions to the first transport vehicle to pick up the item from the pick-up location and deliver the item to the second transport vehicle at the item exchange location. In another example, the transport vehicle module 236 can provide instructions for transferring the item from the first transport vehicle to the second transport vehicle at a particular item exchange location.

The transport vehicle module 236 may also be configured to provide and/or instruct a transport vehicle to update the route to include a new item exchange location. For example, the vehicle may receive a first route with an item exchange location, the transport vehicle module 236 may calculate a new item exchange location, and the transport vehicle module 236 can instruct the vehicle to update the route to include the new item exchange location. In some examples, more than one vehicle may be instructed (e.g., instructing the second vehicle to update a second route to include the new item exchange location). In another example, the route can be updated to form a second route and provided to the first vehicle as part of the instructing of the first vehicle to update the route.

The transport vehicle module 236 may also be configured ensure that a transport vehicle includes particular physical characteristics. For example, the physical characteristics may enable the transport vehicle to store or carry particular items. The transport vehicles can be equipped to store perishable items and/or equipped to carry containers that store perishable items.

The transport vehicle module 236 may also be configured to identify a physical characteristic for a transport vehicle (e.g., in order to transfer an item quickly between transport vehicles or locations). For example, the physical characteristic may be one or more features of the transport vehicle that can be considered when transporting or optimizing the transport of items, including enabling the transport vehicles to exchange items more efficiently.

Various physical characteristics are available. A physical characteristic can be included with a transport vehicle that is not a door. The physical characteristic may be a similar size opening on a side of the first transport vehicle and the second transport vehicle that aligns when the first transport vehicle and the second transport vehicle are next to each other. The physical characteristic may be a ramp between the first transport vehicle and the second transport vehicle to transfer the item between the first transport vehicle and the second transport vehicle. The physical characteristic can include rails in the first transport vehicle and the second transport vehicle that align when the first transport vehicle and the second transport vehicle are next to each other in order to transfer the item between the first transport vehicle and the second transport vehicle. The physical characteristic can include a rack that allows an item container to be transported on the rack between the first and second transport vehicles.

The physical characteristic may enable a transport vehicle to exchange items with a different type of transport vehicle because the physical characteristic replaces at least part of the item exchange infrastructure that is missing from the plurality of potential item exchange locations. For example, the physical characteristic may be a computer system that is normally found at a fulfillment center. The computer system can be installed with a particular type of transport vehicle in order to enable the transport vehicles to use the computer system that is local to the transport vehicle when exchanging the items, instead of a computer system that would normally be provided by the fulfillment center.

In some examples, the compatibility between the physical characteristics can enable automatic transfer and/or automatic exchange of the item from a first vehicle to a second vehicle. For example, the automatic transfer may be capable without unpacking the item from a tote that contains the item and at least another item (e.g., automatic item transfer from a first vehicle to a second vehicle). In another example, a first vehicle is configured to provide the item to the second vehicle without unpacking the item from a tote based at least in part on a common vehicle type.

The transport vehicle module 236 may also be configured to identify different types of vehicles that limit the number of delivery or pick-up locations in the first transport route and second transport route. In some examples, the physical characteristics associated with the transport vehicles may be portable mechanisms configured to operate with the first and second types of vehicles, respectively.

The memory 218 may also include a location module 238. The location module 238 may be configured to identify a base location, pick-up location, drop-off location, or item exchange location. For example, a base location can include a location that stores (e.g., parks) transport vehicles when the vehicles are not in use, including a storage yard, a fulfillment center or item repository parking lot, a garage, and the like. The base location may be identified at the start of a transport route and can factor into a calculation of an optimal item exchange location. For example, one transport vehicle can have a base location in Los Angeles and another transport vehicle can have a base location in San Diego. The determined transport route can include an item exchange location between Los Angeles and San Diego, including Orange County. In another example, the base location may change during a time duration. For example, a transport vehicle may have a base location in Seattle on January 1^{st}, but change the base location to San Francisco on January 10^{th}. In some examples, the base location may change (or stay the same) for the determined transport routes (e.g., one base location on the first day, a different base location on the second day, etc.).

In some examples, the base location can be a home of a consumer. For example, a consumer can provide an item from a residential home. The transport vehicle can begin at the home of the consumer, pick up the item from the consumer, follow a transport route to visit an item exchange location or drop-off location, and provide the item to another transport vehicle.

An item exchange location can include a location where one or more transport vehicles meet to exchange an item. The item exchange location can include a parking lot, commercial retail space, a residential location, a side of the road, under a street light on a sidewalk, and the like. In some examples, the transport vehicle can stop at the item exchange location to avoid stopping at the base location or a brick-and-mortar fulfillment center or repository center. The item exchange location can move, change, or follow a particular transport route (e.g., the item exchange location is located on Main Street in the morning and Alpha Way in the afternoon). The item exchange location can be transiently determined (e.g., the item exchange location is located at Main Street and dynamically changed to Alpha Way based on a transportation factor like a traffic accident). In other examples, the item exchange location can include a fulfillment center or item repository.

A pick-up location or drop-off location can include a location where the transport vehicle visits in order to pick-up or drop-off an item. For example, the transport vehicle may visit an item manufacturer's location to pick-up a loaf of bread (the pick-up location) and also visit a consumer's residential location to drop-off the load of bread (the drop-off location). In some examples, the pick-up or drop-off location may be another transport vehicle, so that one transport vehicle can pick-up a loaf of bread from the side of a truck (the pick-up location) and also visit an item provider's retail location to drop-off the loaf of bread (the drop-off location).

In some examples, the pick-up location identifies an item provider that provides the item and the pick-up location is inaccessible to the second transport vehicle. The first or second base location is a fulfillment center or item repository and the fulfillment center or item repository is stationary independent of a transport route. In some examples, the pick-up location is at an item provider at a residential home. In some examples, the pick-up location is at an item provider (e.g., merchant, consumer that sells items, an auction house, etc.) or at an item manufacturer (e.g., Acme Co. that makes electronics to provide to consumers). In some examples, the pick-up location for an item may be delivered by a first vehicle or a second vehicle, the item is stored at the pick-up location, and retrieved by the first vehicle.

The location module 238 may also be configured to identify a location based on a transportation factor or delivery optimization factor. For example, an item exchange location can be determined in a transport route for a transport vehicle based in part on a transportation factor related to the pick-up location or drop-off location (e.g., when to visit the pick-up location or drop-off location, hours of operation, the cost of visiting the location, other transportation considerations, etc.). The transportation factor can include a schedule of a driver operating the transport vehicle, a cost of operating the transport vehicle with respect to the transport route, an identification of the least amount of overtime for a driver operating the transport vehicle, or other factors that would affect the efficiency, cost, or other measurements for transporting an item.

The location module 238 may also be configured to determine a movable item exchange location. For example, the item exchange location can be movable and be included in a third route of a third transport vehicle. The item exchange location may be located on Main Street in the morning from a transport vehicle and the transport vehicle can move to a different geographical region by the afternoon. The item exchange location may be located on Alpha Way in the afternoon from the same transport vehicle.

The location module 238 may also be configured to identify one or more physical locations for exchange of an item between two vehicles and/or item exchange locations distinct from one or more base locations. The item exchange location may be identified from a plurality of item exchange locations that optimizes a transport route with respect to a transportation factor.

The location module 238 may also be configured to identify a location based on historical data. For example, the plurality of potential item exchange locations can be determined by analyzing historical data to determine potential item exchange locations after one or more of the item exchange locations have been approved.

The location module 238 may also be configured to identify a predetermined amount of time to visit or remain at a location. For example, the predetermined amount of time may be 1 hour, 4 hours, 1 week, or any other suitable variation of time to visit or remain at a location (e.g., an item exchange location). In another example, the transport route for a transport vehicle can be determined to include an item exchange location such that the transport vehicle is scheduled to remain for a predetermined amount of time at the item exchange location. Another transport vehicle can be scheduled to remain at the item exchange location as well. In some embodiments, the transport vehicle may provide services similar to those of a fulfillment center, but also correspond with a transport route that is distinct from the transport vehicle's base location.

The location module 238 may also be configured to identify a plurality of potential item exchange locations that are located in the union of a first geographical region and the second geographical region. The plurality of potential item exchange locations can include one or more movable or temporary locations that are identified for a purpose other than item exchanges and the plurality of potential item exchange locations can remain unsupported by item exchange infrastructure. In some examples, the item exchange location can be determined from the plurality of potential item exchange locations where the first transport vehicle provides the perishable items to the second transport vehicle.

The location module 238 may also be configured to dynamically update the item exchange location to one or more transport routes based in part on one or more transportation factors. For example, the optimal exchange location may be considered based in part on one or more physical characteristics with the transport vehicles that interact to exchange the item at the item exchange location. The item exchange location can be changed based in part on one or more transportation factors. In some examples, the location module 238 may be configured to receive an indication of a new item exchange location (e.g., from a third party, from another module, etc.).

The location module 238 may also be configured to calculate the item exchange location to maximize a number of delivery or pick-up locations in transport route. The maximized number may be based in part on a predicted interaction between first and second types of vehicles using the first and second physical characteristics. In some examples, the locations and routing between locations may be selected responsive to orders generated by an electronic marketplace. The order flow can dynamically influence the selection of the various types of locations.

The memory 218 may also include a transport route module 240. The transport route module 240 may be configured to determine and/or update a first transport route for a first transport vehicle that includes a pick-up location and a second transport route for a second transport vehicle that includes the same pick-up location. In some examples, the transport route can include a pick-up location, item exchange location, begin, and/or end at a base location. For example, the first transport route can include a pick-up of the perishable items from a supplier and the second transport route can include a delivery of the perishable items to a consumer.

The transport routes can include an item exchange location and/or physical location that identifies where a first transport vehicle and a second transport vehicle will exchange the item. In some examples, the item exchange location can include a third route where the item exchange location is moveable for a predetermined amount of time. The item exchange location may be changeable, transiently determined (e.g., distinct from a conventional fulfillment center or warehouse), or stationary for a predetermined amount of time.

The transport route module 240 may also be configured to provide instructions to transport vehicles. For example, route instructions can be provided to a vehicle for providing the item to an item exchange location. In another example, updated instructions may be provided to the transport vehicles (e.g., updated first route instructions for providing the item to a second item exchange location based at least in part on an updated designation).

The transport route module 240 may also be configured to provide updated route(s). For example, the updated route can instruct a vehicle in providing an item to a particular location. The updated route can include more than one route provided to more than one vehicle. For example, the updated first route can be provided to the first vehicle and the updated second route can be provided to the second vehicle to enable delivery of the item by the second vehicle at a time after the item is exchanged at the second item exchange location.

The transport route module 240 may also be configured to identify one or more transport vehicles that can transport the item in accordance with one or more transport routes. The transport routes may be limited by a variety of factors. For example, the transport route can be limited by a schedule of a driver or item provider (e.g., the item provider that provides the item to the transport vehicle).

The transport route module 240 may also be configured to identify how the item is transported. For example, the transport route module 240 may be configured to identify the transportation for the item with the transport vehicle based at least in part on the item starting at the pick-up location and ending at a base location. The item may be transported in accordance with one or more transport routes.

The transport route module 240 may also be configured to adapt or update the transport route to include a new item exchange location. The new item exchange location may be changed from an original item exchange location based on one or more transportation factors or optimization considerations.

The transport route module 240 may also be configured to schedule a pick-up of perishable items from a supplier and/or schedule a delivery of the perishable items to a consumer. The schedule may include more than one transport vehicle, such that the first transport vehicle is scheduled for the pick-up and the second transport vehicle is scheduled for the drop-off. The transport vehicles may meet at an item exchange location to exchange the item after the pick-up but before the drop-off.

The transport route module 240 may also be configured to optimize the delivery of the item based at least in part on optimization criteria. For example, the transport routes can be optimized at least in part by scheduling a transfer of at least one item from the first transport vehicle to the second transport vehicle at the new item exchange location. In another example, optimization criteria can be identified with respect to the first and second transport routes in order to identify one or more stops along the transport route. The optimization criteria can include cost associated with delivery of the item (e.g., cost for storing a perishable item in a refrigerator), a schedule of a driver operating the first transport vehicle or the second transport vehicle, a schedule of a first driver operating the first transport vehicle, a schedule of a second driver operating the second transport vehicle, or a level of access to the second item exchange location by a freeway. In some examples, the route may be optimized based at least in part on a first current location of the first vehicle and a second current location of the second vehicle (e.g., after identifying an item exchange location or physical location for exchange of an item between two vehicles).

The transport route module 240 may also be configured to determine an integral route optimization process. For example, the item exchange location and transport route can be determined as part of an integral route optimization process. A transport route can be determined as part of an integral route optimization process to include the plurality of delivery locations and one of a first item exchange location or second item exchange location. Either the first item exchange location or second item exchange location can be determined as part of the integral route optimization process by identifying a highest ranked item exchange location for a set of criteria.

The transport route module 240 may also be configured to determine an optimized time to meet at the item exchange location, optimized transport route to access the item exchange location, or optimized item packing of the perishable items in the first transport vehicle. The transport route may be calculated to maximize a number of delivery or pick-up locations in the first transport route and second transport route based in part on a predicted interaction between the first and second type of vehicles using the first and second physical characteristics.

The transport route module 240 may also be configured to dynamically update locations in the route. For example, the item exchange location can be updated in one or more transport routes based in part on transportation factors and an optimal exchange location for the physical characteristics to interact to exchange the item at the item exchange location.

The transport route module 240 may also be configured to identify one or more transportation factors. For example, a location can be transiently determined (e.g., the item exchange location is located at Main Street and dynamically changed to Alpha Way based on a transportation factor like a traffic accident). Other transportation factors can consider the roads of the transport route, locations of the item requesters/users, locations of the item providers (e.g., including other transport vehicles), and any other suitable transportation factors that may affect the efficiency of a first transport route in comparison with a second transport route option. Still other transportation factors can consider a schedule of the driver for a transport vehicle, hours of an item provider, traffic data, delivery locations, or pick-up locations.

The memory 218 may also include an item module 242. The item module 242 may be configured to identify an item. For example, the item may be identified as being purchased, sold, exchanged, won, lost, or otherwise needed to transport from one location to another. The item may be perishable (e.g., fruit, meat, dairy) or not perishable (e.g., clothing, electronics).

When the item is perishable, the transport route may be restricted based in part on the perishable item. For example, the item may be transported at night, in comparison to transporting the item during the day when the weather is unbearably hot along a transport route in a desert. In another example, the transport route may be restricted to a limited number of hours of transport (e.g., so that the item can remain fresh). In some examples, the locations (e.g., item exchange location) and/or transport vehicle(s) can include refrigerated storage to store the perishable item.

The item module 242 may also be configured to manage the item. For example, the management of the item can include managing an item available through an electronic marketplace, where the electronic marketplace includes at least the item. The item may be perishable, so that the management of the item includes the management of a perishable item in an electronic marketplace.

The item module 242 may also be configured to identify an item container to store an item. A plurality of perishable items can be stored on or in an item container for perishable items and the item container for perishable items can be loaded to a transport vehicle. The locations on a transport route may accept the item container when the transport vehicle stops at the location to drop-off the item (e.g., at an item exchange location or drop-off location). The item container can take various forms, including a storage rack that can store one or more refrigerated totes, a tote with refrigerated material to store the perishable item, a box that sits on a shelf of a storage rack, or a storage rack that rolls on the rails between a first transport vehicle and a second transport vehicle.

The item module 242 may also be configured to identify physical characteristics of one or more transport vehicles to transport an item (e.g., in combination with the transport vehicle module 236). For example, the height of the item container can be identified and correlated with the transport vehicle to transfer the perishable items quickly from a first transport vehicle to a second transport vehicle without unpacking the perishable items from the item container or tote including a plurality of other perishable items.

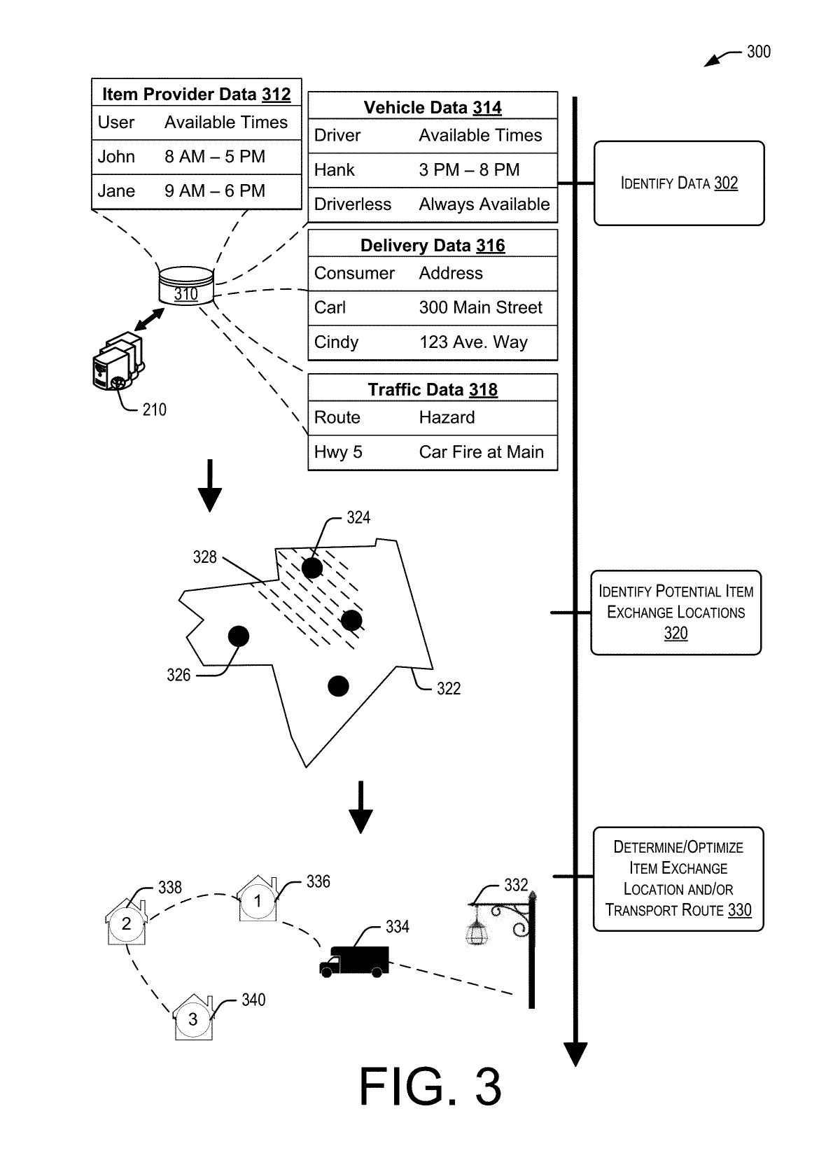

FIG. 3 illustrates an illustrative flow for route scheduling of multi-type transport vehicles described herein, according to at least one example. In a non-limiting example, the method 300 can identify data 302. For example, the transportation management computer 210 can access a data store 310 to identify the data. The data can include item provider data 312, transport vehicle data 314, delivery data 316, and traffic data 318. Other types of data are accessible as well.

The item provider data 312 can include one or more entries identifying an item provider and any suitable information that may be used when determining a transport route that includes a pick-up or drop-off at an item provider. For example, the information can include any suitable times for pick-up, drop-off, or names of the item provider (e.g., item provider John is available 8 AM to 5 PM, item provider Jane is available 9 AM to 6 PM, etc.). In another example, the data may include the pick-up location with an item provider and the pick-up location may be inaccessible to the second vehicle. The data may also include consumer data, item manufacturer data, or other entities that can provide or request an item for transport.

The transport vehicle data 314 can include one or more entries identifying transport vehicle data or related information that may be helpful when determining a transport route for a transport vehicle. For example, the transport vehicle data 314 can include the transport vehicle driver and their available times for transporting items (e.g., driver Hank is available 3 PM to 8 PM Monday through Friday). In some examples, the transport vehicle data 314 can identify driverless transport vehicles and corresponding data (e.g., driverless vehicle is always available, driverless vehicle is out for maintenance January 10-14, etc.).

The delivery data 316 can include information related to consumers, item providers, item exchange locations, transport vehicles, drop-off locations, or other entities or locations that can accept a delivery. For example, a consumer at a residential location can be listed in deliver data 316 for the available times that they can accept the delivery of the item (e.g., Carl is located at 300 Main Street and will be home after 6 PM, Cindy is located at 123 Avenue Way, etc.).

The traffic data 318 can include one or more streets or portions of transport routes that may affect the quick/efficient delivery of the item. For example, a fire, traffic hazard, accident, road closure, or other temporary or permanent traffic data may affect the transport route from an estimated time to a delayed time (e.g., highway 5 includes a car fire near the Main Street exit). One or more entries in traffic data 318 may be considered as a transportation factor.

In some examples, the traffic data 318 can be used to identify a transportation factor. The transportation factors can include a schedule of the driver for the first transport vehicle or the second transport vehicle, hours of an item provider, traffic data, delivery locations, pick-up locations, or factors to consider when arriving at any suitable location (e.g., traveling restrictions, holiday hours, road closures, etc.).

The method 300 can identify potential item exchange locations 320. For example, the plurality of potential item exchange locations can be located in the union of one or more geographical regions and include one or more potential item exchange locations. The potential item exchange locations can include one or more movable or temporary locations that are identified for a purpose other than item exchanges (e.g., a parking lot, street parking, etc.). In another example, the potential item exchange locations can be determined by analyzing historical data to determine potential item exchange locations after one or more of the item exchange locations have been approved.

The potential item exchange locations can be identified for a geographical region 322 or a union of one or more geographical regions and include a first potential item exchange location 324 and a second potential item exchange location 326. For example, the geographical region 322 can include all areas between Los Angeles and San Diego, and the geographical region 322 can be Orange County, an area between or at the union of geographies associated with Los Angeles and San Diego.

An optimized geographical region 328 can be identified within the geographical region 322. One or more item exchange locations within the optimized geographical region 328 may be selected as the item exchange location for a particular transport route (e.g., item exchange location 324 located within the optimized geographical region 328). The optimized geographical region 328 can be identified using various methods and algorithms known for calculating an optimized geographical region.

The method 300 can determine or optimize the item exchange location and/or transport route 330. For example, the transport route can begin at base location (not shown) or item exchange location 332. A transport vehicle 334 can stop at the item exchange location 332, pick-up the item, and stop at one or more drop-off locations 336, 338, or 340. In some examples, the transport vehicle may also pick-up items from locations 336, 338, or 340, and/or may visit the locations in a particular order to minimize time, maximize efficiency, or any other reason identified by the transport management computer 210.

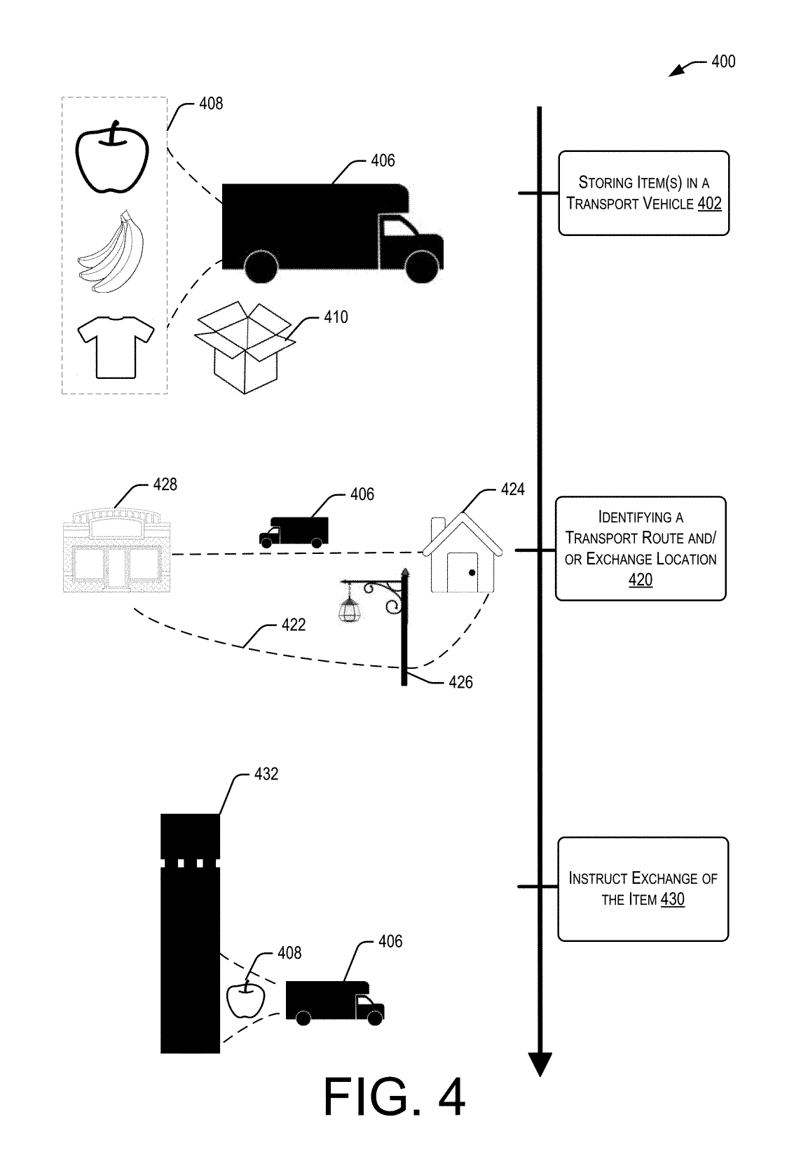

FIG. 4 illustrates an illustrative flow of different types of transport vehicles interacting and exchange an item described herein, according to at least one example. In a non-limiting example, the method 400 can store items in a transport vehicle 402. For example, the transport vehicle 406 can store one or more items 408 that are perishable (e.g., fruit, meat, dairy) or not perishable (e.g., clothing, electronics). The transport vehicle 406 can store the items in an item container 410, including a box, rack, tote, rail, pallet, or other container used for carrying items.

The method 400 can identify a transport route and/or item exchange location 420. For example, the transport route 422 can identify a start location, intermediate locations, and an end location. The start and end location may be the same place. As illustrated, a transport vehicle 406 can follow a transport route 422 that starts at a base location 424, visits an item exchange location 426, visits a pick-up or drop-off location 428, and then returns to the base location 424 at the end of the transport route.

The method 400 can instruct exchange of the item 430. For example, the transport route 422 can identify an item exchange location between two types of transport vehicles 406 and 432. One or more types of transport vehicles can transport the item and/or exchange the item with the other type of transport vehicle. As illustrated, the first transport vehicle 406 can pick-up the item from the pick-up location 428 and meet the second transport vehicle 432 at an item exchange location 426. The first transport vehicle 406 can provide the item 408 to the second transport vehicle 432, or vice versa. Once exchanged, one or both transport vehicles may continue on their transport routes to pick-up, drop-off, or meet other transport vehicles at other item exchange locations.

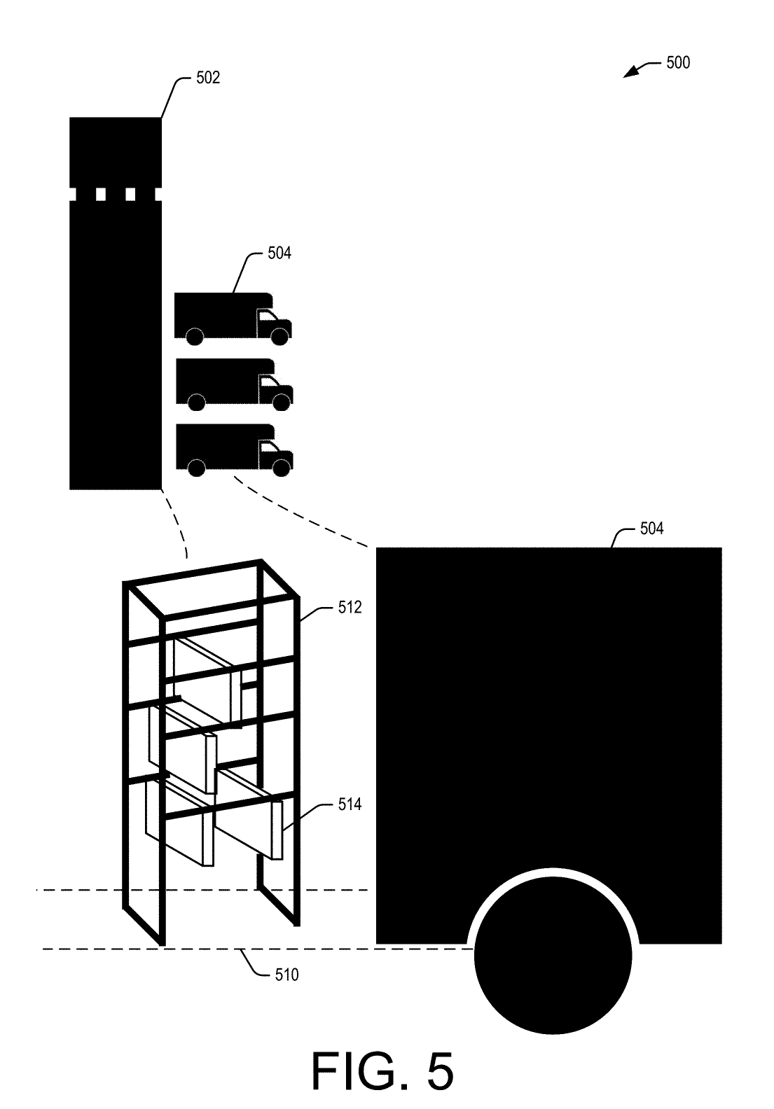

FIG. 5 illustrates an interaction of different types of transport vehicles described herein, according to at least one example. In a non-limiting example, the illustration 500 can include one or more types of transport vehicles, including transport vehicles 502, 504. The transport vehicles can include one or more physical characteristics that allow the transport vehicles to efficiently exchange the items and/or item containers. For example, the transport vehicle 504 may be equipped with rails or a ramp 510 that allows the transport vehicle 504 to accept the item by rolling the items and/or item containers on the rails or ramp between transport vehicles 502 and 504.

In another example, the height of the item container 512 may be a physical characteristic configured to align with the height of a transport vehicle or height of an opening of a transport vehicle. When the height of the item container aligns with the height of the height of a transport vehicle or height of an opening of a transport vehicle, the item container containing items may be transported as a whole, instead of moving the items off the item container, walking the items to the second transport vehicle, and placing the items on a second item container.

In yet another example, the item container 514 can be a tote or box that is placed on a larger item container. The item container 514 can be refrigerated or temperature controlled in order to substantially maintain the temperature of the item during transport (e.g., during transport on a transport route, during transport between transport vehicle 502 and 504, during transport on rails or a ramp 510, etc.).

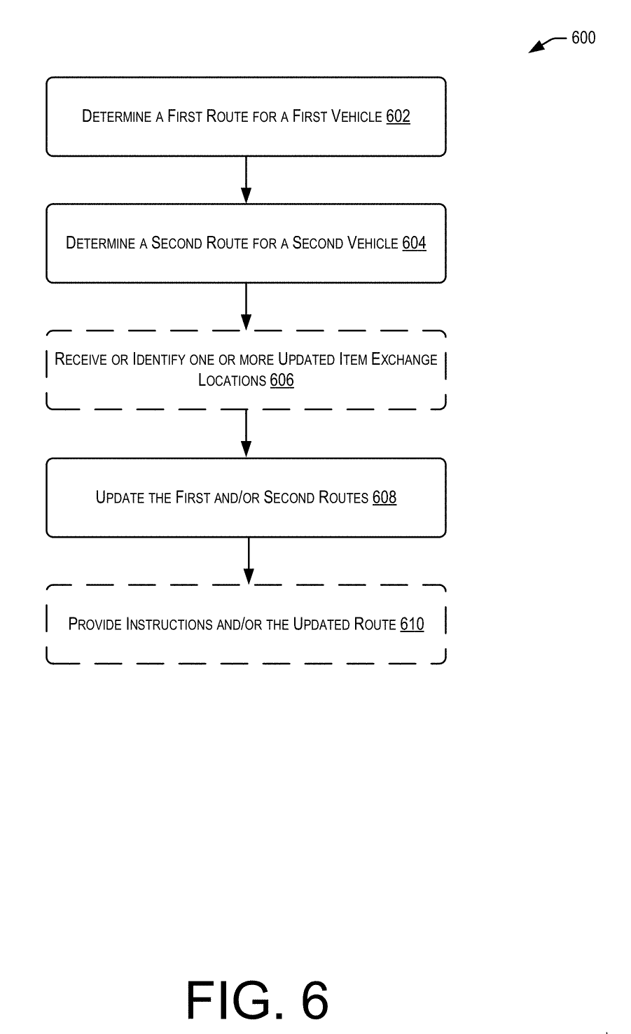

FIG. 6 illustrates an example flow diagram for route scheduling of multi-type transport vehicles described herein, according to at least one example. In some examples, the one or more transportation management computers 210 (e.g., utilizing at least one of the transport vehicle module 236, the location module 238, the transport route module 240, and/or the item module 242) or one or more user devices 204 shown in FIG. 2 may perform the process 600 of FIG. 6. The process 600 may begin at 602 by determining a first route for a first vehicle. The first route may be a first transport route and the first vehicle may be a first transport vehicle. In some examples, the first vehicle can be governed by a first set of transport rules. The transport rules can identify a first geographical region that is accessible to the transport vehicle. The first transport route can include (e.g., begin, middle, and/or end) at a first base location of the first transport vehicle. In some examples, the first vehicle may begin and end the first route at the first base location.

In some examples, the first transport route can include a pick-up of an item from an item provider at a pick-up location that is inaccessible to a second transport vehicle. The second transport vehicle may be governed by a second set of transport rules. The second set of transport rules that identify a second geographical region that is accessible to the second transport vehicle. In some examples, the first geographical region is distinct from the second geographical region. The first transport route can also include a transfer of the item from the first transport vehicle to the second transport vehicle at a first item exchange location that is distinct from the first base location. In some examples, the item may be a perishable item. In some examples, the first transport route can include a pick-up location, item exchange location, and/or a drop-off location. In some examples, the first route can include a pick-up location and a first item exchange location. The pick-up location can identify the first location for the first vehicle to pick up an item for delivery.

At 604, the process 600 may include determining a second route for a second vehicle. The second route may be a second transport route and the second vehicle may be a second transport vehicle. For example, the second transport route for the second transport vehicle can at least include a second base location for the second transport vehicle and include a transfer of the item at the first item exchange location. The second vehicle may begin and end the second route at the second base location. In another example, the determined second transport route can include the pick-up location and an item exchange location. The item exchange location can identify where the first transport vehicle and the second transport vehicle will exchange the item. In some examples, the item exchange location can be included in a third route where the item exchange location is moveable for a predetermined amount of time. In some examples, the second route can include a delivery location and the first item exchange location. The first item exchange location can identify a physical location for exchange of the item between the first vehicle and the second vehicle. In yet other examples, the second route can include the first item exchange location and a second base location, the first item exchange location identifying where the first vehicle and the second vehicle are to exchange the item.

At 606, where the process 600 may optionally include receiving or identifying one or more updated item exchange locations. For example, a first transport route and a second transport route may be updated to include the updated item exchange location in place of the first item exchange location for the transfer of the item. In another example, a second item exchange location may be identified as a second physical location for the exchange of the item between the first vehicle and the second vehicle. The second item exchange location can be utilized for the exchange of the item.

At 608, where the process 600 may include updating the first and/or second routes. For example, at least one of the first route or the second route can be updated to replace the physical location with the second physical location based at least in part on the identified second item exchange location. In another example, the first route and the second route can be updated to include an updated item exchange location instead of the first item exchange location.

Further in some examples, the process 600 may end at 610, where the process 600 may include optionally include providing instructions. The instructions may be for the transfer of the item at the updated item exchange location. In some examples, the instructions can identify transporting an item with the first and second transport vehicles in accordance with the routes. For example, transporting the item with the first transport vehicle and the second transport vehicle can be in accordance with the first transport route and the second transport route, based at least in part on the item starting at the pick-up location and ending at the second base location.

In some examples, an updated route is optionally provided. For example, the updated first route can be provided to the first vehicle and the updated second route can be provided to the second vehicle. The updated routes can enable delivery of the item by the second vehicle at a time after the item is exchanged at the second item exchange location.

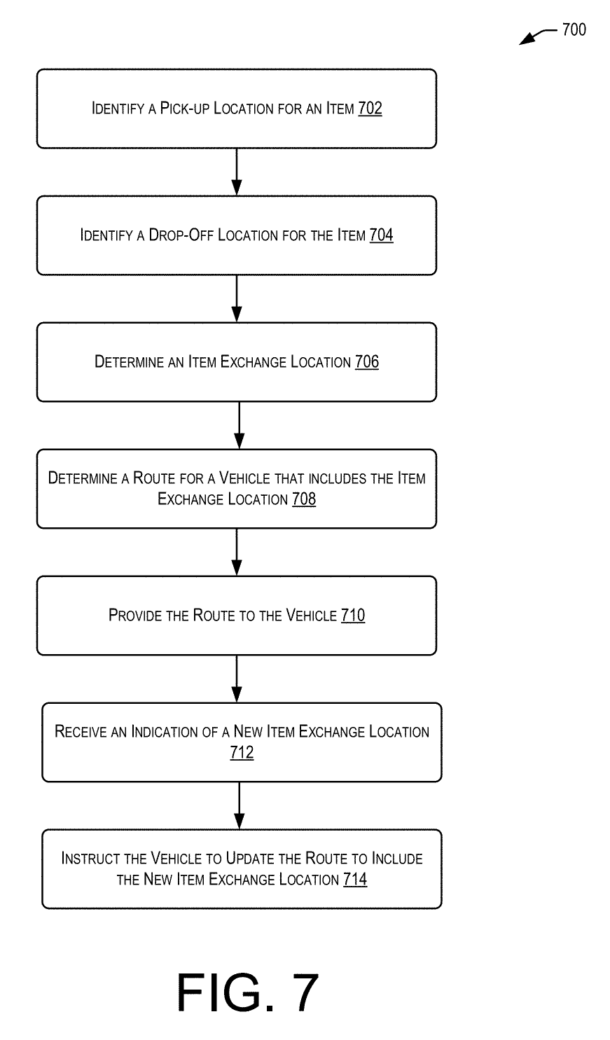

FIG. 7 illustrates an example flow diagram for route scheduling of multi-type transport vehicles described herein, according to at least one example. In some examples, the one or more transportation management computers 210 (e.g., utilizing at least one of the transport vehicle module 236, the location module 238, the transport route module 240, and/or the item module 242) or one or more user devices 204 shown in FIG. 2 may perform the process 700 of FIG. 7. The process 700 may begin at 702 by identifying a pick-up location for an item. For example, the pick-up location can provide the item to the first transport vehicle. The pick-up location can be identified for an item to be delivered by a first vehicle and a second vehicle. The item may be stored at the pick-up location and retrieved by the first vehicle.

At 704, the process 700 may include identifying a drop-off location for the item. For example, the drop-off location can accept the item by a consumer. In some examples, the drop-off location can be identified for delivery of the item, to a consumer, by the second vehicle. At 706, the process 700 may include determining an item exchange location. For example, the item exchange location can be located in a transport route for the first transport vehicle based in part on a transportation factor related to the pick-up location or drop-off location. In some examples, the item exchange location can be determined for exchanging the item between the first vehicle and the second vehicle based in part on one or more transportation factors.

At 708, the process 700 may include determining a route for a first vehicle that includes the item exchange location and the pick-up location. In some examples, the transport route for the vehicle can be determined that includes exchanging the item with a second vehicle. At 710, the process 700 may include providing the route to the first vehicle. At 712, the process 700 can include receiving an indication of a new item exchange location. Further in some examples, the process 700 may end at 714, where the first vehicle is instructed to update the route to include the new item exchange location. In some examples, the second vehicle is also instructed to update a second route to include the new item exchange location. In another example, the route can be updated to form a second route and the process 700 can include providing the second route to the first vehicle as part of the instructing of the first vehicle to update the route.

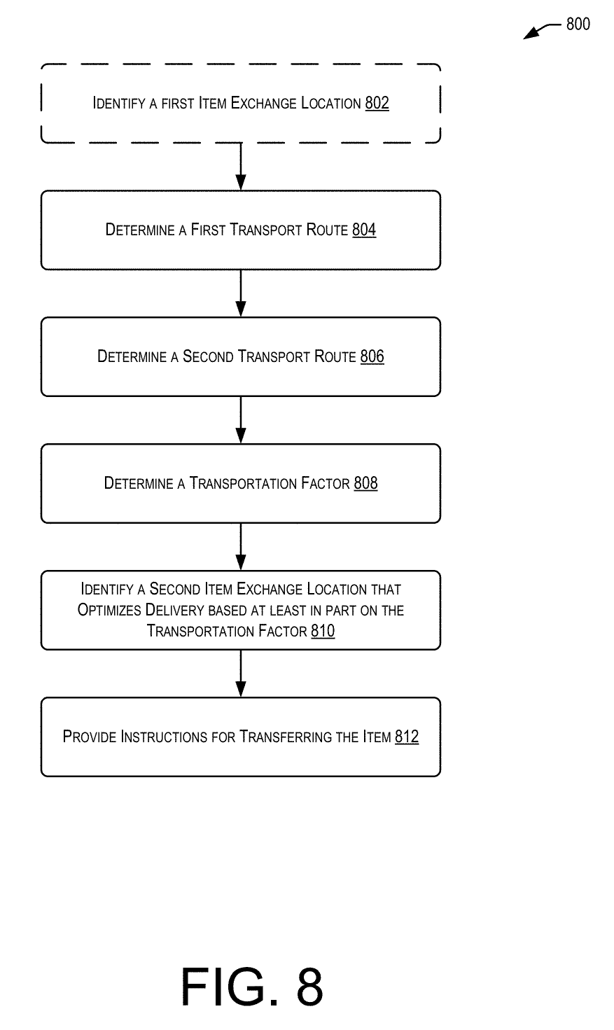

FIG. 8 illustrates an example flow diagram for establishing a transient warehouse described herein, according to at least one example. In some examples, the one or more transportation management computers 210 (e.g., utilizing at least one of the transport vehicle module 236, the location module 238, the transport route module 240, and/or the item module 242) or one or more user devices 204 shown in FIG. 2 may perform the process 800 of FIG. 8. The process 800 may optionally begin at 802 by identifying a first item exchange location distinct from a first base location. The first item exchange location can correspond to a first transport vehicle and be distinct from a second base location corresponding to a second transport vehicle. Block 802 may be optional in some embodiments. In some examples, the process may begin at 804 by determining a first transport route. For example, the first transport route can be determined for a first transport vehicle. The first transport route can begin and/or end at the first base location. In some examples, the first transport route can include the first item exchange location. In some examples, the first transport vehicle and second transport vehicle can exchange an item, and the item may be perishable.

At 806, the process 800 may include determining a second transport route. For example, a second transport route can be determined for the second transport vehicle such that the second transport route begins and/or ends at the second base location. The second transport route can also include the first item exchange location. At 808, the process 800 may include determining a transportation factor. In some examples, the transportation factor affects an efficiency of delivery of a perishable item available from the first base location.

At 810, the process 800 may include identifying a second item exchange location among a plurality of item exchange locations that optimizes the delivery of the perishable item. For example, the optimization may be based at least in part on the determined transportation factor. The transportation factor can include traffic, closed roads, a schedule of a driver operating the first transport vehicle, a cost of operating the first transport vehicle with respect to the transport route, an identification of the least amount of overtime for a driver operating the first transport vehicle, and the like. Further in some examples, the process 800 may end at 812, where the process 800 may include providing instructions for transferring the perishable item. The item may be transferred from the first transport vehicle to the second transport vehicle at the second item exchange location.

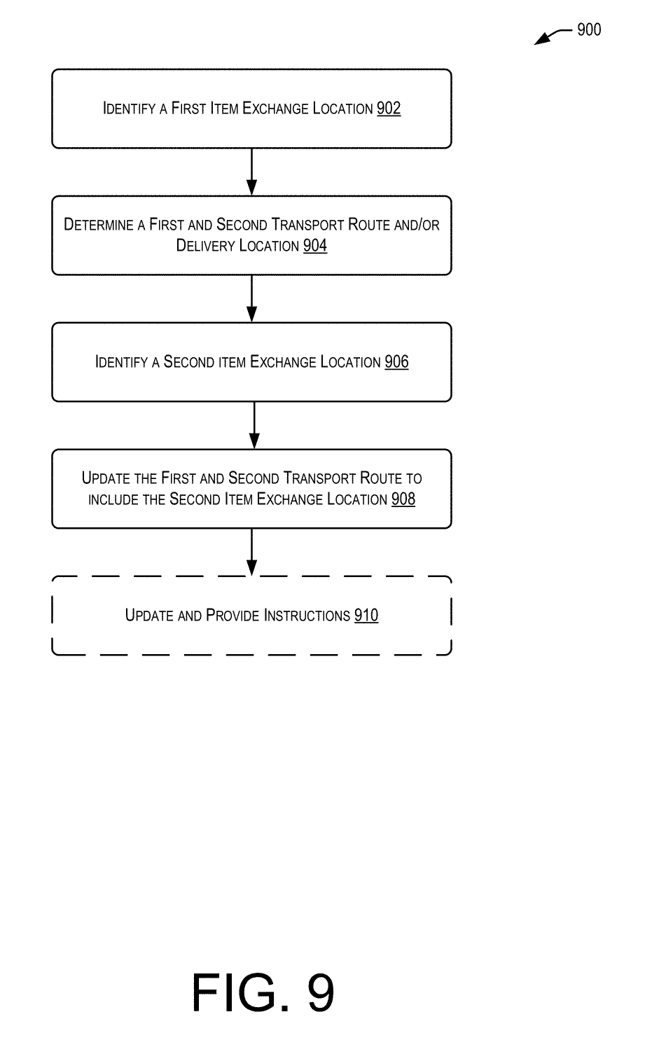

FIG. 9 illustrates an example flow diagram for establishing a transient warehouse described herein, according to at least one example. In some examples, the one or more transportation management computers 210 (e.g., utilizing at least one of the transport vehicle module 236, the location module 238, the transport route module 240, and/or the item module 242) or one or more user devices 204 shown in FIG. 2 may perform the process 900 of FIG. 9. The process 900 may begin at 902 by identifying a first item exchange location. The first item exchange location may be associated with transferring an item from a first vehicle to a second vehicle. In some examples, the first item exchange location is identified from a plurality of item exchange locations. The first item exchange location can be designated for exchanging the item between a first vehicle and a second vehicle. At 904, the process 900 may include determining a first and second transport route and/or a delivery location. For example, the first transport route may be determined for the first vehicle that includes at least a first base location and a first item exchange location. The second transport route may be determined that includes at least a second base location and a first item exchange location. In some examples, the first item exchange location may be identified with a particular transportation factor. In some examples, a delivery location is identified for the item. First route instructions may be provided to the first vehicle. The first route instructions can be for providing the item to the first item exchange location.

At 906, the process 900 may include identifying a second item exchange location. The second item exchange location may be associated with transferring the item from the first vehicle to the second vehicle. The second item exchange location may be identified to optimize delivery of the item to a user based at least in part on a transportation factor. In some examples, the process 900 may determine to update the designation for exchanging the item between the first vehicle and the second vehicle from the first item exchange location to the second item exchange location of the plurality of potential item exchange locations. The determination may be based on at least in part on an optimization factor.

At 908, the first and second transport routes may be updated to include the second item exchange location. In some examples, the instructions associated with the routes are updated. For example, the first route instructions to the first vehicle are updated for providing the item to the second item exchange location based at least in part on the updated designation. In some examples, the first transport vehicle and the second transport vehicle can be scheduled to remain for a predetermined amount of time at the item exchange location.

Further in some examples, the process 900 may end at 910, where the process 900 includes updating and providing the instructions. For example, the second route instructions can be provided to the second vehicle for retrieving the item from the first vehicle at the second item exchange location.

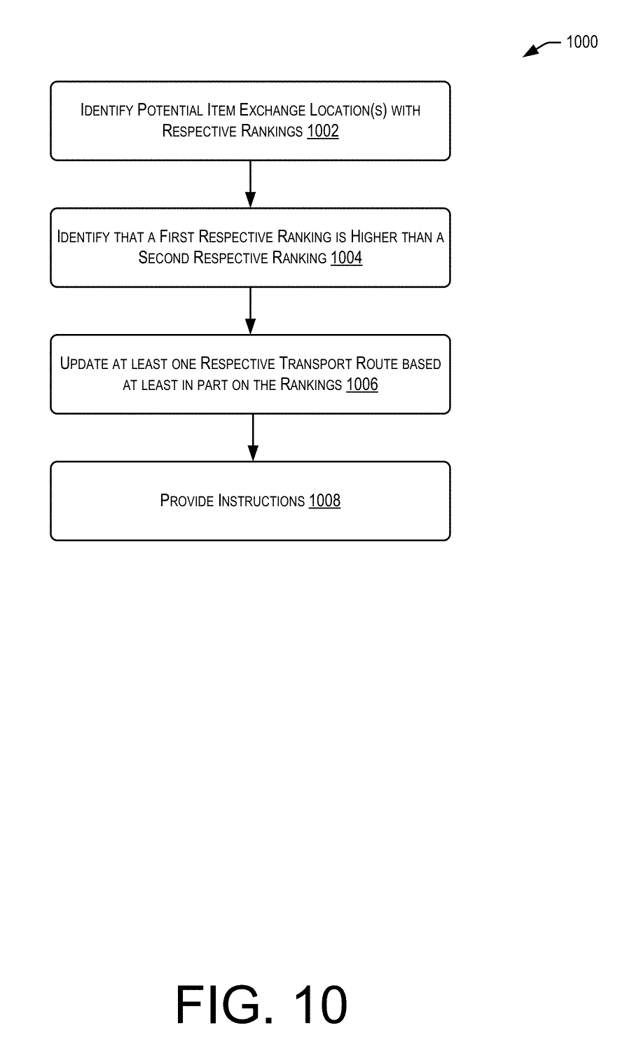

FIG. 10 illustrates an example flow diagram for establishing a transient warehouse described herein, according to at least one example. In some examples, the one or more transportation management computers 210 (e.g., utilizing at least one of the transport vehicle module 236, the location module 238, the transport route module 240, and/or the item module 242) or one or more user devices 204 shown in FIG. 2 may perform the process 1000 of FIG. 10. The process 1000 may begin at 1002 by identifying a potential item exchange location. For example, a plurality of potential item exchange locations can be identified with respective rankings. The plurality of potential item exchange locations can include at least a first item exchange location and a second item exchange location for transferring an item between a first vehicle and a second vehicle. At 1004, the process 1000 may include identifying that a first respective ranking is higher than a second respective ranking. For example, the identification may be based at least in part on a delivery optimization factor. The first respective ranking of the first item exchange location may be higher than a second respective ranking of the second item exchange location. At 1006, the process 1000 may include updating at least one respective transport route based at least in part on the rankings. For example, at least one respective transport route for at least one of the first vehicle or the second vehicle can be updated to include the first item exchange location in place of the second item exchange location based at least in part on the first respective ranking being higher than the second respective ranking. Further in some examples, the process 1000 may end at 1008, where the process 1000 may include providing instructions. For example, the instruction may be provided for transferring the item between the first vehicle and the second vehicle at the first item exchange location. The instructions may be provided for the second vehicle to provide the item to a destination. In another example, either the first item exchange location or second item exchange location can be determined as part of the integral route optimization process by identifying a highest ranked item exchange location for a set of criteria.

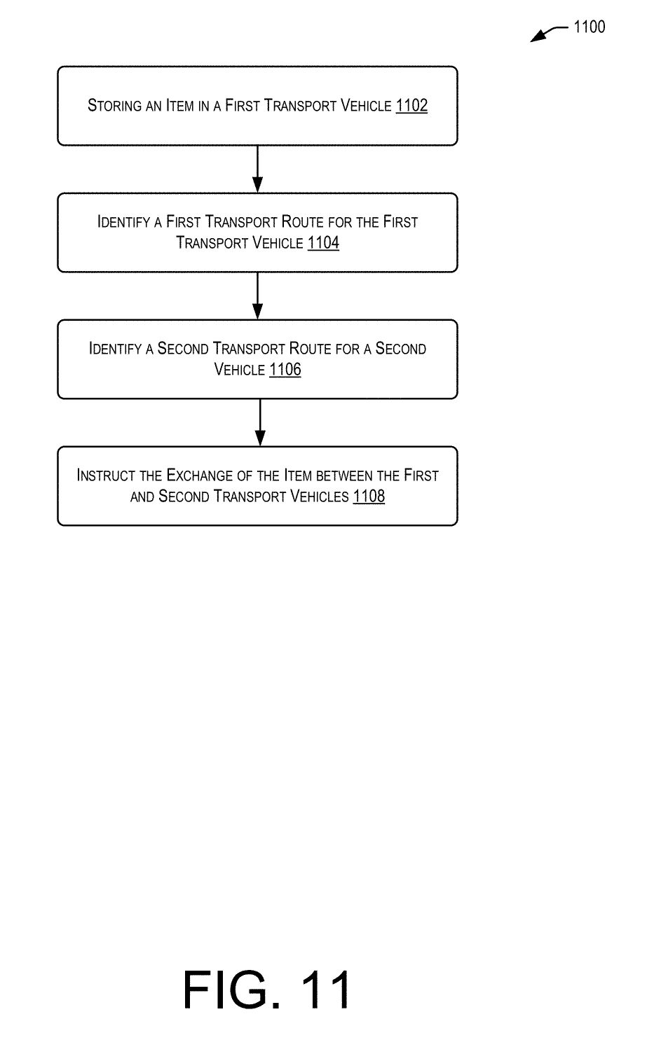

FIG. 11 illustrates an example flow diagram for an interaction of different types of transport vehicles described herein, according to at least one example. In some examples, the one or more transportation management computers 210 (e.g., utilizing at least one of the transport vehicle module 236, the location module 238, the transport route module 240, and/or the item module 242) or one or more user devices 204 shown in FIG. 2 may perform the process 1100 of FIG. 11. The process 1100 may begin at 1102 by storing an item in a first transport vehicle. For example, a plurality of perishable items can be stored on an item container for perishable items. The item container for perishable items can be loaded to a first transport vehicle. At 1104, the process 1100 may include identifying a first transport route for the first transport vehicle. For example, the first transport route can include a pick-up location where the first transport vehicle acquires the item container for perishable items and an item exchange location. In another example, the first transport route can include a pick-up location where the first transport vehicle acquires the item and an item exchange location, and the first transport vehicle can have a first physical characteristic for a first type of vehicle.

At 1106, the process 1100 may include identifying a second transport route for a second transport vehicle. For example, the second transport route can include the item exchange location. In some examples, the second transport vehicle can have a physical characteristic for a second type of vehicle. Further in some examples, the process 1100 may end at 1108, where the process 1100 may include instructing the exchange of the item between the first and second transport vehicles. For example, the exchange can include an exchange of the item container for the perishable items at the item exchange location. The height of the item container can be constructed to transfer the perishable items quickly from the first transport vehicle to the second transport vehicle, without unpacking the perishable items from the item container or tote including a plurality of other perishable items. In another example, the first physical characteristic of the first transport vehicle and the second physical characteristic of the second transport vehicle can be constructed to transfer the item quickly from the first transport vehicle to the second transport vehicle, independent of the different door heights or sizes for the first and second types of vehicles.

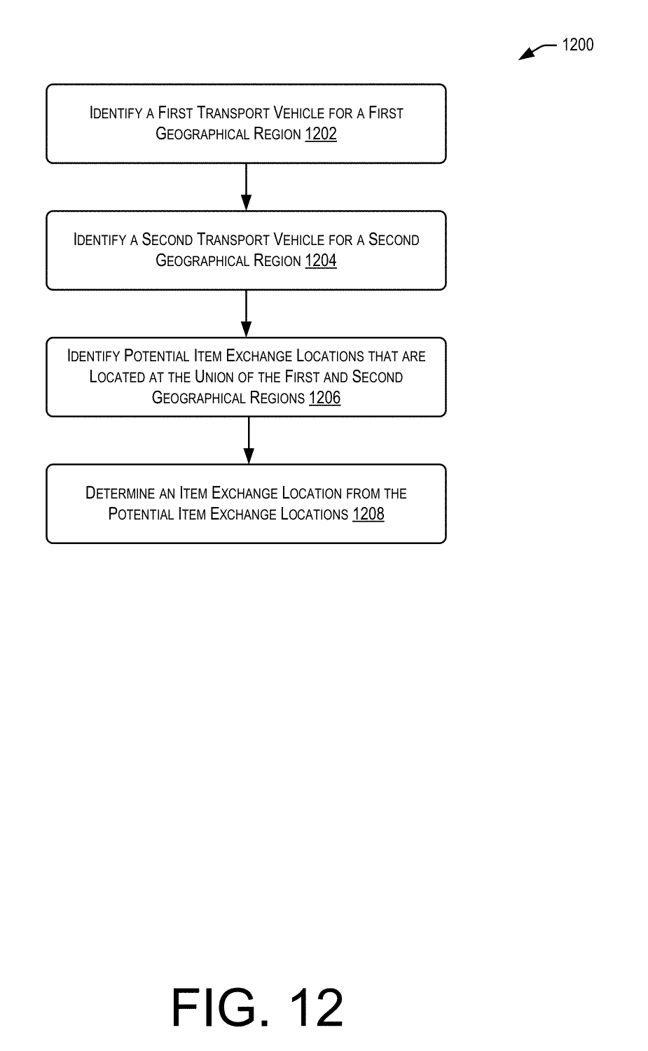

FIG. 12 illustrates an example flow diagram for an interaction of different types of transport vehicles described herein, according to at least one example. In some examples, the one or more transportation management computers 210 (e.g., utilizing at least one of the transport vehicle module 236, the location module 238, the transport route module 240, and/or the item module 242) or one or more user devices 204 shown in FIG. 2 may perform the process 1200 of FIG. 12. The process 1200 may begin at 1202 by identifying a first transport vehicle for a first geographical region. For example, a first transport vehicle can be identified for a first geographical region. The first transport vehicle can pick up the perishable items from one or more item providers. The first transport vehicle can be included in a first type of vehicles. At 1204, the process 1200 may include identifying a second transport vehicle for a second geographical region. For example, a second transport vehicle can be identified for a second geographical region. The second transport vehicle can be from a second type of vehicles and the second transport vehicle can be configured to include a physical characteristic that enables the second transport vehicle to exchange items with the first type of transport vehicle. At 1206, the process 1200 may include identifying potential item exchange locations that are located at the union of the first and second geographical regions. For example, a plurality of potential item exchange locations can be identified that are located in the union of the first geographical region and the second geographical region. The plurality of potential item exchange locations can include one or more movable or temporary locations that are identified for a purpose other than item exchanges and the plurality of potential item exchange locations can be unsupported by item exchange infrastructure. Further in some examples, the process 1200 may end at 1208, where the process 1200 may include determining an item exchange location from the potential item exchange locations. For example, an item exchange location can be determined from the plurality of potential item exchange locations where the first transport vehicle provides the perishable items to the second transport vehicle.

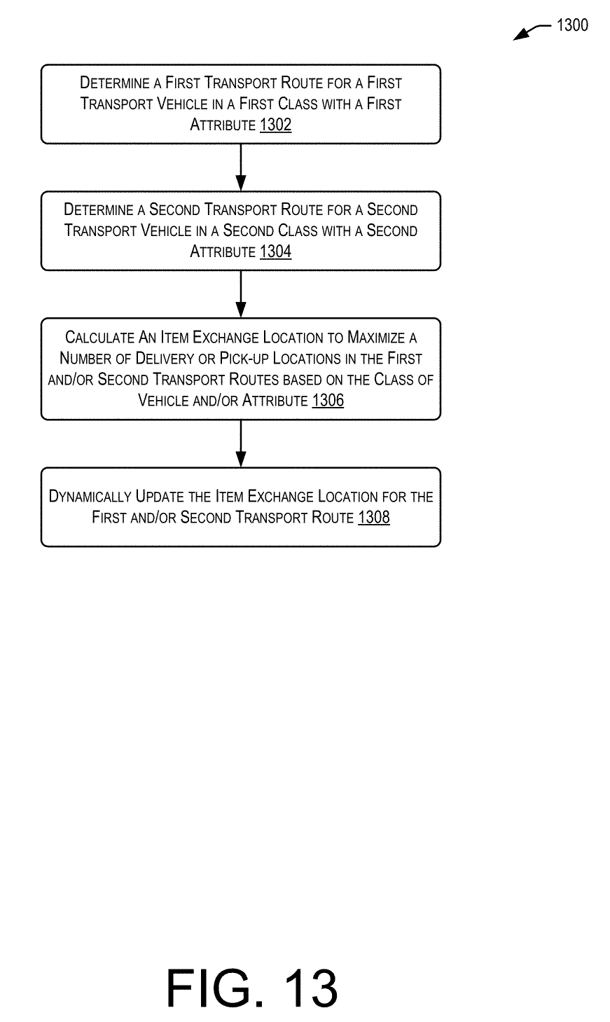

FIG. 13 illustrates an example flow diagram for an interaction of different types of transport vehicles described herein, according to at least one example. In some examples, the one or more transportation management computers 210 (e.g., utilizing at least one of the transport vehicle module 236, the location module 238, the transport route module 240, and/or the item module 242) or one or more user devices 204 shown in FIG. 2 may perform the process 1300 of FIG. 13. The process 1300 may begin at 1302 by determining a first transport route for a first transport vehicle in a first type with a first physical characteristic. For example, the first transport vehicle can be limited by a first transportation factor and the first transport vehicle can be equipped with a first physical characteristic for a first type of vehicle. The first transport route can include a first set of delivery or pick-up locations. At 1304, the process 1300 may include determining a second transport route for a second transport vehicle in a second type with a second physical characteristic. For example, the second transport vehicle can be limited by a second transportation factor. The second transport vehicle can be equipped with a second physical characteristic for a second type of vehicle. The second transport route can include a second set of delivery or pick-up locations.

At 1306, the process 1300 may include calculating an item exchange location to maximize a number of delivery or pick-up locations in the first and/or second transport routes based on the type of vehicle and/or physical characteristic. For example, the item exchange location can be calculated to maximize a number of delivery or pick-up locations in the first transport route and second transport route based in part on a predicted interaction between the first and second type of vehicles using the first and second physical characteristics. Further in some examples, the process 1300 may end at 1308, where the process 1300 may include dynamically updating the item exchange location for the first and/or second transport routes. For example, the item exchange location can be dynamically updated in the first transport route and the second transport route based in part on the first transportation factor and the second transportation factor. The item exchange location can be the optimal item exchange location for the first and second physical characteristics to interact to exchange the item.

Illustrative methods and systems for providing image analysis/management are described above. Some or all of these systems and methods may, but need not, be implemented at least partially by architectures such as those shown at least in FIGS. 1-13 above.

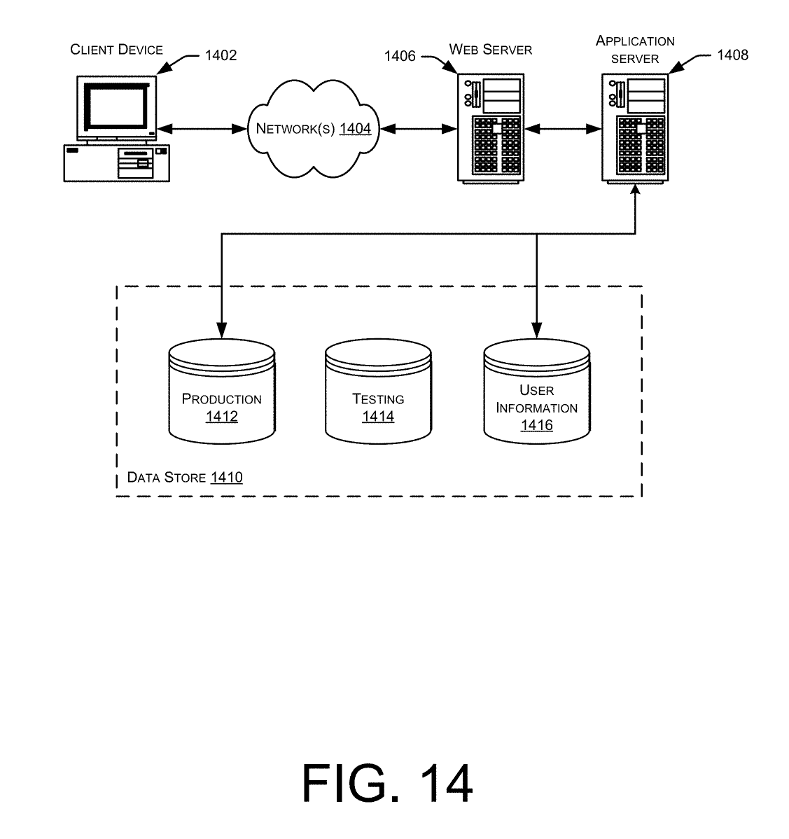

FIG. 14 illustrates aspects of an example environment 1400 for implementing aspects in accordance with various embodiments. As will be appreciated, although a Web-based environment is used for purposes of explanation, different environments may be used, as appropriate, to implement various embodiments. The environment includes an electronic client device 1402, which can include any appropriate device operable to send and receive requests, messages, or information over an appropriate network 1404 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1406 for receiving requests and serving content in response thereto, although for other networks an alternative device serving a similar purpose could be used as would be apparent to one of ordinary skill in the art.

The illustrative environment includes at least one application server 1408 and a data store 1410. It should be understood that there can be several application servers, layers, or other elements, processes or components, which may be chained or otherwise configured, which can interact to perform tasks such as obtaining data from an appropriate data store. As used herein the term “data store” refers to any device or combination of devices capable of storing, accessing, and/or retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device, handling a majority of the data access and business logic for an application. The application server provides access control services in cooperation with the data store, and is able to generate content such as text, graphics, audio and/or video to be transferred to the user, which may be served to the user by the Web server in the form of HTML, XML or another appropriate structured language in this example. The handling of all requests and responses, as well as the delivery of content between the client device 1402 and the application server 1408, can be handled by the Web server. It should be understood that the Web and application servers are not required and are merely example components, as structured code discussed herein can be executed on any appropriate device or host machine as discussed elsewhere herein.

The data store 1410 can include several separate data tables, databases or other data storage mechanisms and media for storing data relating to a particular aspect. For example, the data store illustrated includes mechanisms for storing production data 1412 and user information 1416, which can be used to serve content for the production side. The data store also is shown to include a mechanism for storing log data 1414, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 1410. The data store 1410 is operable, through logic associated therewith, to receive instructions from the application server 1408 and obtain, update or otherwise process data in response thereto. In one example, a user might submit a search request for a certain type of item. In this case, the data store might access the user information to verify the identity of the user, and can access the catalog detail information to obtain information about items of that type. The information then can be returned to the user, such as in a results listing on a web page that the user is able to view via a browser on the user device 1402. Information for a particular item of interest can be viewed in a dedicated page or window of the browser.

Each server typically will include an operating system that provides executable program instructions for the general administration and operation of that server, and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 14. Thus, the depiction of the system 1400 in FIG. 14 should be taken as being illustrative in nature, and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk®. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java® servers, and business application servers. The server(s) also may be capable of executing programs or scripts in response requests from user devices, such as by executing one or more Web applications that may be implemented as one or more scripts or programs written in any programming language, such as Java®, C, Visual C#® or C++, or any scripting language, such as Perl®, Python® or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer-readable media for containing code, or portions of code, can include any appropriate media known or used in the art, including storage media and communication media, such as but not limited to volatile and non-volatile, removable and non-removable media implemented in any method or technology for storage and/or transmission of information such as computer-readable instructions, data structures, program modules or other data, including RAM, ROM, EEPROM, flash memory or other memory technology, CD-ROM, DVD, or other optical storage, magnetic cassettes, magnetic tape, magnetic disk storage or other magnetic storage devices or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as that included in the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, and/or at least one of Z in order for each to be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1.-20. (canceled)

21. A first transport vehicle comprising:
an engine;
a physical structure configured to transfer a perishable item from the first transport vehicle to a second transport vehicle;
a positioning system that provides first transport vehicle data; and
a communication apparatus for receiving instructions from a computer system, the computer system configured to:
receive an order of a perishable item via an electronic marketplace provided by the computer system, the computer system also being associated with the first transport vehicle and the second transport vehicle, the second transport vehicle having a smaller capacity size than the first transport vehicle,
and the second transport vehicle having at least one physical characteristic that is capable of transferring the perishable item from the first transport vehicle and the second transport vehicle;
determine, by the computer system, a first transport route of the first transport vehicle based at least in part on the first transport vehicle data, the first transport vehicle governed by a first set of transport rules that identify a first geographical region that is accessible to the first transport vehicle, the first transport route at least including a first base location of the first transport vehicle, the first transport route including:
a pick-up of the perishable item from an item provider at a pick-up location that is inaccessible to the second transport vehicle governed by a second set of transport rules that identify a second geographical region that is accessible to the second transport vehicle, and the second transport vehicle capable of providing second transport vehicle data; and
the transfer of the perishable item from the first transport vehicle to the second transport vehicle at a first item exchange location that is distinct from the first base location and is determined based at least in part on a first transportation factor and a delivery location;
determine a freshness restriction to a transport time of the perishable item to maintain freshness;
determine a capacity restriction in the first set of transport rules that restricts traveling of the first transport vehicle having a larger capacity size than the second transport vehicle;
determine, by the computer system, a second transport route of the second transport vehicle, the second transport route at least including a second base location of the second transport vehicle and including the transfer of the perishable item at the first item exchange location, the second transport route being different than the first transport route based at least in part on the capacity restriction of the first transport vehicle;
receive an updated item exchange location, the updated item exchange location determined based at least in part on a second transportation factor, the freshness restriction to the transportation time, and the delivery location;
update the first transport route and the second transport route to include the updated item exchange location in place of the first item exchange location where the transfer of the perishable item occurs, based at least in part on the first transport vehicle data and the second transport vehicle data; and
provide, by the computer system, instructions to transfer the perishable item at the updated item exchange location, physical movement of the perishable item by the first transport vehicle along the first transport route and by the second transport vehicle along the second transport route being based at least in part on the instructions; wherein the first transport vehicle:
physically transports the perishable item according to the capacity restriction and the freshness restriction to the transport time to maintain freshness; and
causes the perishable item to be moved from the first transport vehicle to the second transport vehicle, the movement caused by an operation of the first transport vehicle to move the perishable item.

22. The first transport vehicle of claim 21, wherein the second transportation factor enables a delivery performance for the perishable item to be above a threshold.

23. The first transport vehicle of claim 21, wherein the first geographical region is different from the second geographical region.

24. The first transport vehicle of claim 21, wherein the first base location is configured for parking the first transport vehicle at least one of before or after completion of the first transport route.

25. The first transport vehicle of claim 21, wherein the second base location is a fulfillment center or item repository for managing the perishable item.

26. The first transport vehicle of claim 21, wherein the first item exchange location or the updated item exchange location is a parking lot, a commercial retail space, or a roadside location.

27. A computer-implemented method, comprising:
receiving, by a computer system in communication with a first vehicle and the communication via a communication apparatus between the first vehicle and the computer system, an order of an item via an electronic marketplace provided by a computer system, the computer system also being associated with the first vehicle and a second vehicle, the second vehicle having a smaller capacity size than the first vehicle, and the first vehicle and the second vehicle each having at least one physical characteristic that is capable of transferring the item from the first vehicle and the second vehicle;
determining, by the computer system, a first route of the first vehicle based at least in part on first vehicle data, the first route including a pick-up location and a first item exchange location determined based at least in part on a transportation factor, the pick-up location identifying a first location of the first vehicle to pick up the item, the first vehicle equipped with a positioning system that provides the first vehicle data;
determining a capacity restriction that restricts traveling of the first vehicle having a larger capacity size than the second vehicle;
determining a second route of the second vehicle, the second vehicle capable of providing second vehicle data, the second route including a delivery location and the first item exchange location, the first item exchange location identifying a physical location to transfer the item between the first vehicle and the second vehicle, the second route being different than the first route based at least in part on the capacity restriction of the first vehicle;
identifying a second item exchange location as a second physical location to transfer the item between the first vehicle and the second vehicle, the second item exchange location determined based at least in part on a change to the transportation factor;
identifying that the second item exchange location should be utilized to transfer the item;
updating at least one of the first route or the second route to replace the physical location with the second physical location based at least in part on the second item exchange location, and based at least in part on the first vehicle data and the second vehicle data, physical movement of the item by the first vehicle along the first route and by the second vehicle along the second route being based at least in part on the capacity restriction of the first vehicle;
physically transporting, by the first vehicle, the item according to the capacity restriction of the first vehicle; and
causing, by the first vehicle, the item to be moved from the first vehicle to the second vehicle.

28. The computer-implemented method of claim 27, wherein the first vehicle is governed by a first set of transport rules that restrict traveling by the first vehicle and the second vehicle is governed by a second set of transport rules that restrict traveling by the second vehicle different from the first set of transport rules.

29. The computer-implemented method of claim 28, wherein the first set of transport rules identify a first geographical region that is accessible to the first vehicle and the second set of transport rules identify a second geographical region that is accessible to the second vehicle.

30. The computer-implemented method of claim 29, wherein the first geographical region is different from the second geographical region.

31. The computer-implemented method of claim 29, wherein at least one of the first item exchange location or the second item exchange location includes a union of the first geographical region and the second geographical region.

32. The computer-implemented method of claim 27, wherein the item is perishable, and wherein at least one of the first route or second route is restricted based in part on the item being perishable.

33. The computer-implemented method of claim 27, wherein the pick-up location is associated with an item provider that provides the item and the pick-up location is inaccessible to the second vehicle.

34. The computer-implemented method of claim 27, wherein at least one of the first route or the second route is limited by a schedule of a driver.

35. The computer-implemented method of claim 27, wherein at least one of the first route or the second route is optimized based at least in part on a first current location of the first vehicle and a second current location of the second vehicle when the first route and the second route are updated with the second physical location.
